(19) United States
(12) Patent Application Publication
(10) Pub. No.: US 2026/0250545 A1
(43) Pub. Date: Aug. 27, 2026

(54) POLYMERIC COMPOSITION

(71) Applicant: CHASE CORPORATION, Westwood, MA (US)

(72) Inventors: Bijan Radmard, Norwood, MA (US); Chris Brightwell, Westwood, MA (US); Matthew Eveline, Westwood, MA (US); Jacek Knop, Westwood, MA (US); Rachana Upadhyay, Westwood, MA (US); Keith Waryold, Oyster Bay, NY (US)

(21) Appl. No.: 19/160,222

(22) PCT Filed: Feb. 28, 2024
(86) PCT No.: PCT/US2024/017594

§ 371 Date: Aug. 27, 2025

Related U.S. Application Data
(60) Provisional application No. 63/448,938, filed on Feb. 28, 2023.

(51) Int. Cl. C09D 175/04; C08G 18/79; C08G 18/83; C08G 77/08; C08K 5/544; C09D 5/08; C09D 5/16; C09D 7/20; C09D 7/61; C09D 7/63; C09D 7/80

(52) U.S. Cl. CPC C09D 175/04; C08G 18/791; C08G 18/837; C08G 77/08; C08K 5/544; C09D 5/08; C09D 5/165; C09D 7/20; C09D 7/61; C09D 7/63; C09D 7/80

(57) ABSTRACT

This disclosure generally relates to compositions suitable to provide thin (e.g., ultra-thin) coatings, and methods of preparing the compositions thereof. The compositions comprise one or more silyl-terminated polymers and one or more carriers. The compositions can be used as protective coatings for electronics applications, or as anti-corrosion, scratch-resistant, or haptic coatings for various substrates.

### TECHNICAL FIELD

This disclosure generally relates to compositions suitable to provide thin (e.g., ultra-thin) coatings, and methods of preparing the compositions thereof.

### BACKGROUND

Thin coatings (e.g., ultra-thin coatings) for electronic assemblies can provide protection against moisture, corrosive environment, dirt, and contaminants for electronic circuit boards, and prevent electrocution as a protective coating for LED assemblies. Thin coating technology for electronics applications typically utilizes either a fluorinated electronic coating, which has high cost and very selective adhesion to various substrates, or a parylene coating applied by chemical vapor deposition, which requires capital investment in specialized equipment for the application and heating process.

### SUMMARY

In one aspect, described herein are examples of a composition that can include one or more silyl-terminated polymers and one or more carriers. The silyl-terminated polymer is present in the composition from about 5% to about 75% by weight. The carrier is present in the composition from about 20% to about 90% by weight. The coating composition is suitable to provide a coating having a thickness of less than about 130 microns.

In an aspect, the coating has a thickness of less than about 100 microns, less than about 50 microns, less than about 25 microns, less than about 15 microns, or less than about 12.5 microns. In an aspect, the coating has a thickness of less than about 12.5 microns.

In an aspect, the coating substantially conforms to IPX7 waterproof standards of the International Electrochemical Commission.

In an aspect, the coating is resistant against degradation from chemicals and/or sweat.

In an aspect, the coating has no discoloration, change in gloss, blistering, softening, swelling, and/or loss of adhesion after being exposed to chemicals in a chemical resistance test according to ASTM D-2792. In an aspect, the coating is exposed to chemicals for a period of at least 24 hours.

In an aspect, the coating has a current leakage of less than about 0.7 μA after being immersed in an artificial sweat solution with an applied electrical power of about 9V.

In an aspect, the artificial sweat solution comprises about 1 g of urea, about 0.5 g of ammonium chloride, about 1 g of lactic acid, and about 1 L of water. In an aspect, the coating is immersed in the artificial sweat solution for about 30 hours.

In an aspect, the coating provides adhesion to materials selected from FR4, polyimide, ceramics, copper, and tin-plated steel. In an aspect, the polyimide is a Kapton film.

In an aspect, the coating has a surface insulation resistance (SIR) value of above about 1GΩ. In an aspect, the coating has a SIR value of above about 1 GO after more than about 20 hours, about 40 hours, about 60 hours, about 80 hours, about 100 hours, about 120 hours, about 140 hours, or about 160 hours.

In an aspect, the coating is resistant against moisture having a moisture insulation resistance (MIR) value above about 5 GΩ. In an aspect, the coating is resistant against moisture having a MIR value above about 25 GΩ, about 50 GΩ, about 75 GΩ, about 100 GΩ, about 125 G, about 150 GΩ, or about 165 GΩ. In an aspect, the coating has the MIR value after one, two, three, four, five, six, seven, eight, nine, or ten temperature humidity cycles.

In an aspect, the coating is resistant to yellowing. In an aspect, the coating has a yellowness factor (b*) of below about 0.4 after heating at about 175° C. In an aspect, the heating is for more than about 1 day, more than about 7 days, or more than about 14 days.

In an aspect, the coating is resistant to thermal shock having no bubbles, cracking, delamination, and/or blistering after more than about 10 cycles, about 20 cycles, about 30 cycles, about 40 cycles, about 50 cycles, about 60 cycles, about 70 cycles, about 80 cycles, about 90 cycles, or about 100 cycles. In an aspect, the cycles were carried out between about −65° C. to about 125° C.

In an aspect, the coating is resistant to cracking and/or crazing when bent about 90°, about 120°, about 150°, or about 180° using a mandrel tester.

In an aspect, the coating is resistant to thermal humidity aging having no discoloration, cracking, and/or delamination after being exposed to a humidity chamber. In an aspect, the humidity chamber is at about 85° C. and about 95% relative humidity (RH). In an aspect, the coating is exposed to the humidity chamber for more than about 30 days, more than about 60 days, more than about 90 days, or more than about 120 days.

In an aspect, the coating has a current leakage of less than about 10 μA, less than about 5 μA, less than about 1 μA, less than about 0.5 μA, or less than about 0.1 μA as measured in a Dielectric Withstand Voltage test according to IPC-TM-650 2.5.7.1.

In an aspect, the coating meets the minimum horizontal burning test standard as carried out according to a UL94 Flammability test.

In an aspect, the coating does not have biological growth in a fungus resistance test according to IPC-TM-650 2.6.1.1. In an aspect, the coating is exposed to fungus for a duration of about 28 days.

In an aspect, the coating substantially conforms to Institute for Interconnecting and Packaging Electronic Circuits (IPC) requirements for an Ultra-Thin (UT) type coating according to IPC-CC-830C specification.

In an aspect, wherein the one or more silyl-terminated polymers comprise polyurethane, polyether, polyacrylic, or combinations thereof.

In an aspect, the silyl-terminated polymer is present in the composition from about 5% to about 50% by weight, about 5% to about 30% by weight, about 10% to about 20% by weight, about 5% to about 15% by weight, or about 10% to about 15% by weight. In an aspect, the silyl-terminated polymer is present in the composition in about 13% by weight. In an aspect, the silyl-terminated polymer is present in the composition in about 16% by weight.

In an aspect, the one or more carriers comprise an organic solvent. In an aspect the one or more carriers comprise an alcohol. In an aspect, the one or more carriers comprise a C₁-C₆ alcohol. In an aspect, the one or more carriers comprise Isopropyl alcohol. In an aspect, the one or more carriers comprise a hydrocarbon solvent. In an aspect, the one or more carriers comprise xylene and methylcyclohexene.

In an aspect, the carrier is present in the composition from about 30% to about 85% by weight, about 50% to about 90% by weight, about 30% to about 80% by weight, about 75% to about 90% by weight, about 80% to about 90% by weight, or about 80% to about 85% by weight. In an aspect, the carrier is present in the composition in about 87% by weight. In an aspect, the carrier is present in the composition in about 80% by weight.

In an aspect, the composition further comprises a moisture cure catalyst. In an aspect, the moisture cure catalyst is a tin catalyst. In an aspect, the moisture cure catalyst is a non-tin catalyst.

In an aspect, the moisture cure catalyst is present in the composition from about 0.01 to about 2% by weight, about 0.01 to about 1% by weight, about 0.1% to about 2% by weight, or about 0.05% to about 0.1% by weight. In an aspect, the moisture cure catalyst is present in the composition in about 0.08% by weight. In an aspect, the moisture cure catalyst is present in the composition in about 0.6% by weight.

In an aspect, the composition further comprises an amine synergist. In an aspect, the amine synergist comprises 3-aminopropyltriethoxy silane.

In an aspect, the amine synergist is present in the composition from about 0.01% to about 15% by weight, about 0.01% to about 2% by weight, about 0.1% to about 2% by weight, or about 0.05% to about 0.5% by weight. In an aspect, the amine synergist is present in the composition in about 0.1% by weight. In an aspect, the amine synergist is present in the composition in about 1% by weight.

In an aspect, the composition further comprises a crosslinker. In an aspect, the crosslinker comprises tris(3-trimethoxysilylpropyl isocyanurate), tetra ethyl orthosilicate, or combinations thereof.

In an aspect, the crosslinker is present in the composition from about 0.01% to about 10% by weight, about 0.1% to about 10%, about 1% to about 10% by weight, or about 0.5% to about 5% by weight. In an aspect, the crosslinker is present in the composition in about 1% by weight. In an aspect, the crosslinker is present in the composition in about 2.4% by weight.

In an aspect, the coating composition further comprises an adhesion promoter. In an aspect, the adhesion promoter comprises vinyl trimethoxy silane, vinyl triethoxy silane, or combinations thereof.

In an aspect, the adhesion promoter is present in the composition from about 0.05% to about 5% by weight, about 0.5% to about 5% by weight, or about 0.1% to about 1% by weight. In an aspect, the adhesion promoter is present in the composition in about 0.5% by weight.

In an aspect, the composition further comprises a wetting agent. In an aspect, the wetting agent is present in the composition from about 0.5% to about 5% by weight, about 1% to about 5% by weight, about 1% to about 3% by weight, or about 1% to about 2% by weight. In an aspect, the wetting agent is present in the composition in about 1.5% by weight.

In an aspect, the composition further comprises an optical brightener. In an aspect, the optical brightener is present in the composition from about 0.01% to about 1% by weight, or about 0.01% to about 0.5% by weight. In an aspect, the optical brightener is present in the composition in about 0.1% by weight.

In an aspect, the composition further comprises one or more inorganic fillers. In an aspect, the one or more inorganic fillers are present in the composition from about 0.01% to about 50% by weight.

In an aspect, the composition further comprises one or more bulking agents. In an aspect, the one or more bulking agents are present in the composition from about 0.01% to about 30% by weight.

In an aspect, the composition further comprises one or more thixotropic agents. In an aspect, the one or more thixotropic agents are present in the composition from about 0.01% to about 10% by weight.

In an aspect, the composition is substantially free from fluorochemicals.

In an aspect, the composition is a one-part composition.

In an aspect, the composition is a two-part composition having a first-part component and a second-part component. In an aspect, the first-part component comprises the one or more silyl-terminated polymers in one or more carriers and the second-part component comprises the moisture cure catalyst in one or more carriers. In an aspect, the second-part component further comprises water.

In an aspect, the coating composition is suitable for curing at an ambient temperature.

In one aspect, described herein are examples of a coating composition that can include: about 5% to about 50% silyl-terminated polymer; about 30% to about 90% carrier; about 0.01% to about 2% moisture cure catalyst; about 0.01% to about 2% amine synergist; about 0.1% to about 10% crosslinker; about 0.05% to about 5% adhesion promoter; and about 0.5% to about 5% wetting agent.

In one aspect, described herein are examples of a coating composition that can include: about 5% to about 30% silyl-terminated polymer; about 75% to about 90% carrier; about 0.01% to about 1% moisture cure catalyst; about 0.05% to about 0.5% amine synergist; about 0.5% to about 5% crosslinker; about 0.1% to about 1% adhesion promoter; and about 1% to about 3% wetting agent.

In one aspect, described herein are examples of a coating composition that can include: about 5% to about 50% silyl-terminated polymer; about 30% to about 90% carrier; about 0.01% to about 2% moisture cure catalyst; about 0.01% to about 2% amine synergist; and about 0.1% to about 10% crosslinker.

In one aspect, described herein are examples of a coating composition that can include: about 5% to about 30% silyl-terminated polymer; about 75% to about 90% carrier; about 0.01% to about 1% moisture cure catalyst; about 0.1% to about 2% amine synergist; and about 0.5% to about 5% crosslinker.

In one aspect, described herein are examples of a coating composition that can include: about 5% to about 50% silyl-terminated polymer; about 0.01% to about 2% moisture cure catalyst; about 0.01% to about 2% amine synergist; and about 0.1% to about 10% crosslinker.

In one aspect, described herein are examples of a coating composition that can include: about 5% to about 30% silyl-terminated polymer; about 0.01% to about 1% moisture cure catalyst; about 0.1% to about 2% amine synergist; and about 0.5% to about 5% crosslinker.

In one aspect, described herein are examples of a coating composition that can include one or more silyl-terminated polymers and one or more carriers, wherein: the coating composition is suitable to provide a coating having a thickness of less than about 12.5 microns; the coating substantially conforms to IPX7 waterproof standards of the International Electrochemical Commission; the coating has no discoloration, change in gloss, blistering, softening, swelling, and/or loss of adhesion after being exposed to chemicals in a chemical resistance test according to ASTM D-2792; and the coating provides adhesion to materials selected from FR4, polyimide, ceramics, copper, and tin-plated steel.

In one aspect, described herein are examples of a coating composition that can include one or more silyl-terminated polymers and one or more carriers, wherein: the coating composition is suitable to provide a coating having a thickness of less than about 12.5 microns; the coating substantially conforms to IPX7 waterproof standards of the International Electrochemical Commission; the coating has no discoloration, change in gloss, blistering, softening, swelling, and/or loss of adhesion after being exposed to chemicals in a chemical resistance test according to ASTM D-2792; the coating has a current leakage of less than about 0.7 μA after being immersed in an artificial sweat solution with an applied electrical power of about 9V; the coating provides adhesion to materials selected from FR4, polyimide, ceramics, copper, and tin-plated steel; the coating has a SIR value of above about 1 GO after more than about 20 hours; the coating is resistant against moisture having a MIR value above about 5 GΩ; the coating has a yellowness factor (b*) of below about 0.4 after heating at about 125° C.; the coating is resistant to thermal shock having no bubbles, cracking, delamination, or blistering after more than about 10 cycles; and the coating is resistant to cracking and/or crazing when bent about 90° using a mandrel tester.

In one aspect, a method of preparing the coating compositions disclosed herein is described. The method includes the following steps: (a) preparing a mixture comprising the one or more silyl-terminated polymers and the one or more carriers; and (b) stirring the mixture.

In an aspect, the mixture further comprises the adhesion promoter, the crosslinker, the amine synergist, the moisture cure catalyst, and the wetting agent. In an aspect, the mixture further comprises the optical brightener.

In an aspect, the stirring is performed under an inert atmosphere. In an aspect, the inert atmosphere is a nitrogen or argon atmosphere. In an aspect, the inert atmosphere is a nitrogen atmosphere.

In one aspect, a method of preparing a coated substrate is described. The method includes the following steps: (a) applying a coating composition disclosed herein to a substrate; and (b) curing the coating composition at a temperature in a range from about 15° C. to about 80° C.

In an aspect, the applying comprises dip-coating, brushing, or spraying the coating composition.

In one aspect, an apparatus including a coating composition disclosed herein is described.

In one aspect, an apparatus including the coating composition prepared according to a method disclosed herein is described.

In an aspect, the apparatus is an electrical device or a medical device. In an aspect, the electrical device is an electronic component, a light-emitting diode (LED), an electronic circuit board, or an electronic assembly. In an aspect, the electronic assembly is a flexible electronic assembly or a rigid electronic assembly. In an aspect, the electronic circuit board is an electronic printed circuit board comprising hardware that controls the flow of electrical energy to process information or control a system.

In an aspect, the electrical device is an LED. In an aspect, the LED is able to withstand being lit upon immersion in water at an applied electrical power of about 9V. In an aspect, the LED is immersed for a period of about 24 hours, about 48 hours, or about 72 hours.

In one aspect, a surface of a material coated with a coating composition disclosed herein is described.

In one aspect, a surface of a material coated with the coating composition prepared according to a method disclosed herein is described.

In one aspect, described herein are examples of a coating composition that can include one or more silyl-terminated polymers, one or more carriers, and one or more inorganic fillers. In an aspect, the silyl-terminated polymer is present in the composition from about 5% to about 75% by weight; the carrier is present in the composition from about 20% to about 90% by weight; and the one or more inorganic fillers are present in the composition from about 5% to about 75% by weight; and the coating composition is suitable to provide a coating having a thickness of less than about 130 microns.

In an aspect, the coating has a thickness of less than about 100 microns, less than about 50 microns, less than about 25 microns, less than about 15 microns, or less than about 12.5 microns. In an aspect, the coating has a thickness of less than about 12.5 microns.

In an aspect, the coating is resistant to mechanical impact according to ASTM D-2794.

In an aspect, the coating is scratch resistant according to ASTM D-7027.

In an aspect, the silyl-terminated polymer comprises polyurethane, polyether, polyacrylic, or combinations thereof. In an aspect, the silyl-terminated polymer is present in the composition from about 5% to about 50% by weight, about 5% to about 30% by weight, about 10% to about 20% by weight, about 5% to about 15% by weight, or about 10% to about 15% by weight.

In an aspect, the carrier comprises an organic solvent. In an aspect, the carrier is present in the composition from about 30% to about 85% by weight, about 50% to about 90% by weight, about 30% to about 80% by weight, about 75% to about 90% by weight, about 80% to about 90% by weight, or about 80% to about 85% by weight.

In an aspect, the one or more inorganic fillers are present in the composition from about 5% to about 25%, about 25% to about 50%, about 50% to about 75%, about 5% to about 50%, or about 10% to about 40% by weight. In an aspect, the one or more inorganic fillers comprise a metal oxide, a silicate, or combinations thereof.

In an aspect, the one or more inorganic fillers comprise one or more toughening and ruggedization agents. In an aspect, the toughening and ruggedization agents comprise metal oxides, silicates, aluminates, glass beads, nano-spheres, or combinations thereof. In an aspect, the toughening and ruggedization agents comprise zinc oxide, fumed silica, aluminum oxide, silica, polymeric nano-spheres, or a combination thereof.

In an aspect, the one or more inorganic fillers comprise one or more scratch resistance additives. In an aspect, the one or more scratch resistance additives comprise metal oxides, montmorillonite clay, and nano-silica. In an aspect, the one or more scratch resistance additives comprise aluminum oxide, zinc oxide, zirconium oxide, or a combination thereof.

In an aspect, the one or more inorganic fillers have a particle size between from about 1 nm to about 10 μm.

In an aspect, the composition further comprises a moisture cure catalyst. In an aspect, the moisture cure catalyst is a tin catalyst. In an aspect, the moisture cure catalyst is a non-tin catalyst.

In an aspect, the moisture cure catalyst is present in the composition from about 0.01 to about 1% by weight, about 0.1% to about 2% by weight, or about 0.05% to about 0.1% by weight.

In an aspect, the composition further comprises a crosslinker. In an aspect, the crosslinker comprises tris(3-trimethoxysilylpropyl isocyanurate), tetra ethyl orthosilicate, or combinations thereof.

In an aspect, the crosslinker is present in the composition from about 0.01% to about 10% by weight, about 0.1% to about 10%, about 1% to about 10% by weight, or about 0.5% to about 5% by weight.

In an aspect, the coating composition further comprises an adhesion promoter. In an aspect, the adhesion promoter comprises vinyl trimethoxy silane, vinyl triethoxy silane, or combinations thereof. In an aspect, the adhesion promoter is present in the composition from about 0.1% to about 1% by weight.

In an aspect, the composition further comprises an amine synergist. In an aspect, the amine synergist comprises 3-aminopropyltriethoxy silane. In an aspect, the amine synergist is present in the composition from about 0.01% to about 15% by weight, about 0.01% to about 2% by weight, about 0.1% to about 2% by weight, or about 0.05% to about 0.5% by weight.

In an aspect, the composition further comprises a wetting agent. In an aspect, the wetting agent is present in the composition from about 0.5% to about 5% by weight, about 1% to about 5% by weight, about 1% to about 3% by weight, or about 1% to about 2% by weight.

In an aspect, the composition further comprises one or more bulking agents. In an aspect, the one or more bulking agents are present in the composition from about 5% to about 75% by weight. In an aspect, the one or more bulking agents are present in the composition from about 5% to about 25%, about 25% to about 50%, about 50% to about 75%, about 5% to about 50%, or about 10% to about 40% by weight.

In an aspect, the one or more bulking agents comprise a metal oxide, a silicate, an aluminate, glass beads, nano-spheres, nano clay or combinations thereof.

In an aspect, the one or more bulking agents have a particle size between from about 1 nm to about 10 μm.

In an aspect, the composition further comprises one or more UV stabilizers. In an aspect, the one or more UV stabilizers are present in the composition from about 0.01% to about 10% by weight. In an aspect, the one or more UV stabilizers comprise a hindered amine light stabilizer. In an aspect, the one or more UV stabilizers comprise a hindered amine light stabilizer and a benzotriazole.

In an aspect, described herein are examples of a coating composition that can include: about 5% to about 75% by weight silyl-terminated polymers; about 20% to about 90% by weight carrier; about 1% to about 20% crosslinker; about 0.01% to about 2% moisture cure catalyst; about 0.5% to about 5% adhesion promoter; and about 5% to about 75% inorganic filler.

In one aspect, a method of preparing a coated substrate is described. In an aspect, the substrate is glass or plastic. In an aspect, the coating provides protection and ruggedization of the substrate.

In one aspect, described herein are examples of a coating composition that can include one or more silyl-terminated polymers, one or more carriers, and one or more anti-corrosion additives. In an aspect, the silyl-terminated polymer is present in the composition from about 5% to about 75% by weight; the carrier is present in the composition from about 20% to about 90% by weight; and the one or more anti-corrosion additives are present in the composition from about 0.1% to about 15% by weight; and the coating composition is suitable to provide a coating having a thickness of less than about 130 microns.

In an aspect, the coating has a thickness of less than about 100 microns, less than about 50 microns, less than about 25 microns, less than about 15 microns, or less than about 12.5 microns. In an aspect, the coating has a thickness of less than about 12.5 microns.

In an aspect, the coating is anti-corrosive according to ASTM B117. In an aspect, the coating is anti-corrosive according to MIL PRF16173E.

In an aspect, the silyl-terminated polymer comprises polyurethane, polyether, polyacrylic, or combinations thereof. In an aspect, the silyl-terminated polymer is present in the composition from about 5% to about 50% by weight, about 5% to about 30% by weight, about 10% to about 20% by weight, about 5% to about 15% by weight, or about 10% to about 15% by weight.

In an aspect, the carrier comprises an organic solvent. In an aspect, the carrier is present in the composition from about 30% to about 85% by weight, about 50% to about 90% by weight, about 30% to about 80% by weight, about 75% to about 90% by weight, about 80% to about 90% by weight, or about 80% to about 85% by weight.

In an aspect, the one or more anti-corrosion additives are present in the composition from about 0.1% to about 5%, about 0.5% to about 2%, or about 1% to about 10% by weight.

In an aspect, the one or more anti-corrosion additives comprise a metal, a metal phosphate, a metal oxide, a carbamate, a benzotriazole, or a combination thereof. In an aspect, the one or more anti-corrosion additives comprise zinc, zinc phosphate, cerium oxide, a carbamate, a benzotriazole, or a combination thereof.

In an aspect, the composition further comprises a moisture cure catalyst.

In an aspect, the composition further comprises a moisture cure catalyst. In an aspect, the moisture cure catalyst is a tin catalyst. In an aspect, the moisture cure catalyst is a non-tin catalyst.

In an aspect, the moisture cure catalyst is present in the composition from about 0.01 to about 1% by weight, about 0.1% to about 2% by weight, or about 0.05% to about 0.1% by weight.

In an aspect, the composition further comprises a crosslinker. In an aspect, the crosslinker comprises tris(3-trimethoxysilylpropyl isocyanurate), tetra ethyl orthosilicate, or combinations thereof.

In an aspect, the crosslinker is present in the composition from about 0.01% to about 10% by weight, about 0.1% to about 10%, about 1% to about 10% by weight, or about 0.5% to about 5% by weight.

In an aspect, the coating composition further comprises an adhesion promoter. In an aspect, the adhesion promoter comprises vinyl trimethoxy silane, vinyl triethoxy silane, or combinations thereof. In an aspect, the adhesion promoter is present in the composition from about 0.1% to about 1% by weight.

In an aspect, the composition further comprises one or more inorganic fillers. In an aspect, the one or more inorganic fillers are present in the composition from about 5% to about 25%, about 25% to about 50%, about 50% to about 75%, about 5% to about 50%, or about 10% to about 40% by weight.

In an aspect, the one or more inorganic fillers comprise a metal oxide, a silicate, or combinations thereof.

In an aspect, the one or more inorganic fillers comprise one or more toughening and ruggedization agents. In an aspect, wherein the toughening and ruggedization agents comprise metal oxides, silicates, aluminates, glass beads, nano-spheres, or combinations thereof. In an aspect, the toughening and ruggedization agents comprise zinc oxide, fumed silica, aluminum oxide, silica, polymeric nano-spheres, or a combination thereof.

In an aspect, the one or more inorganic fillers comprise one or more scratch resistance additives. In an aspect, the one or more scratch resistance additives comprise metal oxides, montmorillonite clay, and nano-silica. In an aspect, the one or more scratch resistance additives comprise aluminum oxide, zinc oxide, zirconium oxide, or a combination thereof.

In an aspect, the one or more inorganic fillers comprise one or more rheology modifiers. In an aspect, the one or more rheology modifiers comprise clay, silica, chalk, or a combination thereof.

In an aspect, the one or more inorganic fillers have a particle size between from about 1 nm to about 10 μm.

In an aspect, the composition further comprises an amine synergist. In an aspect, the amine synergist comprises 3-aminopropyltriethoxy silane. In an aspect, the amine synergist is present in the composition from about 0.01% to about 15% by weight, about 0.01% to about 2% by weight, about 0.1% to about 2% by weight, or about 0.05% to about 0.5% by weight.

In an aspect, the composition further comprises a wetting agent. In an aspect, the wetting agent is present in the composition from about 0.5% to about 5% by weight, about 1% to about 5% by weight, about 1% to about 3% by weight, or about 1% to about 2% by weight.

In an aspect, the composition further comprises one or more bulking agents. In an aspect, the one or more bulking agents are present in the composition from about 5% to about 75% by weight. In an aspect, the one or more bulking agents are present in the composition from about 5% to about 25%, about 25% to about 50%, about 50% to about 75%, about 5% to about 50%, or about 10% to about 40% by weight.

In an aspect, the one or more bulking agents comprise a metal oxide, a silicate, an aluminate, glass beads, nano-spheres, nano clay or combinations thereof.

In an aspect, the one or more bulking agents have a particle size between from about 1 nm to about 10 μm.

In an aspect, the composition further comprises one or more thixotropic agents. In an aspect, the one or more thixotropic agents are present in the composition from about 0.01% to about 25% by weight. In an aspect, the one or more thixotropic agents comprise polyurea, hydroxypropyl methylcellulose, hydroxyethyl cellulose, or a combination thereof.

In an aspect, the composition further comprises one or more UV stabilizers. In an aspect, the one or more UV stabilizers are present in the composition from about 0.01% to about 10% by weight. In an aspect, the one or more UV stabilizers comprise a hindered amine light stabilizer. In an aspect, the one or more UV stabilizers comprise a hindered amine light stabilizer and a benzotriazole.

In an aspect, the composition further comprises one or more anti-oxidants. In an aspect, the one or more anti-oxidants are present in the composition from about 0.01% to about 15% by weight. In an aspect, the one or more anti-oxidants comprise a hindered amine light stabilizer, a carbamate, a benzotriazole, or a combination thereof.

In an aspect, described herein are examples of a coating composition that can include: about 5% to about 75% by weight silyl-terminated polymers; about 20% to about 90% by weight carrier; about 0.1% to about 15% of the anti-corrosion additives; about 1% to about 20% crosslinker; about 0.01% to about 2% moisture cure catalyst; about 0.5% to about 5% adhesion promoter; and about 5% to about 75% inorganic filler.

In one aspect, a method of preparing a coated substrate is described. In an aspect, the substrate is metal. In an aspect, the substrate is a pipeline. In an aspect, the coating has anti-corrosive properties.

In one aspect, described herein are examples of a coating composition that can include one or more silyl-terminated polymers, one or more carriers, and one or more haptic additives. In an aspect, the silyl-terminated polymer is present in the composition from about 5% to about 75% by weight; the carrier is present in the composition from about 20% to about 90% by weight; and the one or more haptic additives are present in the composition from about 0.01% to about 10% by weight; and the coating composition is suitable to provide a coating having a thickness of less than about 130 microns.

In an aspect, the coating has a thickness of less than about 100 microns, less than about 50 microns, less than about 25 microns, less than about 15 microns, or less than about 12.5 microns. In an aspect, the coating has a thickness of less than about 12.5 microns.

In an aspect, the coating the coating has a durometer hardness of Shore A hardness of from 10 to 80. In an aspect, the coating has a coefficient of friction of from about 0.1 to about 0.9. In an aspect, the coating has a plastic softening temperature of between about 10° C. and 40° C. In an aspect, the coating has a modulus of between about 1 MPa and about 10 MPa.

In an aspect, the silyl-terminated polymer comprises polyurethane, polyether, polyacrylic, or combinations thereof. In an aspect, the silyl-terminated polymer is present in the composition from about 5% to about 50% by weight, about 5% to about 30% by weight, about 10% to about 20% by weight, about 5% to about 15% by weight, or about 10% to about 15% by weight.

In an aspect, the carrier comprises an organic solvent. In an aspect, the carrier is present in the composition from about 30% to about 85% by weight, about 50% to about 90% by weight, about 30% to about 80% by weight, about 75% to about 90% by weight, about 80% to about 90% by weight, or about 80% to about 85% by weight.

In an aspect, the one or more haptic additives are present in the composition from about 0.01% to about 5%, about 0.5% to about 5%, about 0.1% to about 2%, or about 1% to about 10% by weight.

In an aspect, the one or more one or more haptic additives comprise a wax, a polymer, or a combination thereof. In an aspect, the one or more haptic additives comprise a micronized wax, a silicone polymer, a polyurea polymer, or a combination thereof.

In an aspect, the composition further comprises a moisture cure catalyst.

In an aspect, the composition further comprises a moisture cure catalyst. In an aspect, the moisture cure catalyst is a tin catalyst. In an aspect, the moisture cure catalyst is a non-tin catalyst.

In an aspect, the moisture cure catalyst is present in the composition from about 0.01 to about 1% by weight, about 0.1% to about 2% by weight, or about 0.05% to about 0.1% by weight.

In an aspect, the composition further comprises a crosslinker. In an aspect, the crosslinker comprises tris(3-trimethoxysilylpropyl isocyanurate), tetra ethyl orthosilicate, or combinations thereof.

In an aspect, the crosslinker is present in the composition from about 0.01% to about 10% by weight, about 0.1% to about 10%, about 1% to about 10% by weight, or about 0.5% to about 5% by weight.

In an aspect, the coating composition further comprises an adhesion promoter. In an aspect, the adhesion promoter comprises vinyl trimethoxy silane, vinyl triethoxy silane, or combinations thereof. In an aspect, the adhesion promoter is present in the composition from about 0.1% to about 1% by weight.

In an aspect, the composition further comprises one or more inorganic fillers. In an aspect, the one or more inorganic fillers are present in the composition from about 5% to about 25%, about 25% to about 50%, about 50% to about 75%, about 5% to about 50%, or about 10% to about 40% by weight.

In an aspect, the one or more inorganic fillers comprise a metal oxide, a silicate, or combinations thereof.

In an aspect, the one or more inorganic fillers comprise one or more toughening and ruggedization agents. In an aspect, wherein the toughening and ruggedization agents comprise metal oxides, silicates, aluminates, glass beads, nano-spheres, or combinations thereof. In an aspect, the toughening and ruggedization agents comprise zinc oxide, fumed silica, aluminum oxide, silica, polymeric nano-spheres, or a combination thereof.

In an aspect, the one or more inorganic fillers comprise one or more scratch resistance additives. In an aspect, the one or more scratch resistance additives comprise metal oxides, montmorillonite clay, and nano-silica. In an aspect, the one or more scratch resistance additives comprise aluminum oxide, zinc oxide, zirconium oxide, or a combination thereof.

In an aspect, the one or more inorganic fillers comprise one or more rheology modifiers. In an aspect, the one or more rheology modifiers comprise clay, silica, chalk, or a combination thereof.

In an aspect, the one or more inorganic fillers have a particle size between from about 1 nm to about 10 μm.

In an aspect, the composition further comprises an amine synergist. In an aspect, the amine synergist comprises 3-aminopropyltriethoxy silane. In an aspect, the amine synergist is present in the composition from about 0.01% to about 15% by weight, about 0.01% to about 2% by weight, about 0.1% to about 2% by weight, or about 0.05% to about 0.5% by weight.

In an aspect, the composition further comprises a wetting agent. In an aspect, the wetting agent is present in the composition from about 0.5% to about 5% by weight, about 1% to about 5% by weight, about 1% to about 3% by weight, or about 1% to about 2% by weight.

In an aspect, the composition further comprises one or more bulking agents. In an aspect, the one or more bulking agents are present in the composition from about 5% to about 75% by weight. In an aspect, the one or more bulking agents are present in the composition from about 5% to about 25%, about 25% to about 50%, about 50% to about 75%, about 5% to about 50%, or about 10% to about 40% by weight.

In an aspect, the one or more bulking agents comprise a metal oxide, a silicate, an aluminate, glass beads, nano-spheres, nano clay or combinations thereof.

In an aspect, the one or more bulking agents have a particle size between from about 1 nm to about 10 μm.

In an aspect, the composition further comprises one or more thixotropic agents. In an aspect, the one or more thixotropic agents are present in the composition from about 0.01% to about 25% by weight. In an aspect, the one or more thixotropic agents comprise polyurea, hydroxypropyl methylcellulose, hydroxyethyl cellulose, or a combination thereof.

In an aspect, the composition further comprises one or more UV stabilizers. In an aspect, the one or more UV stabilizers are present in the composition from about 0.01% to about 10% by weight. In an aspect, the one or more UV stabilizers comprise a hindered amine light stabilizer. In an aspect, the one or more UV stabilizers comprise a hindered amine light stabilizer and a benzotriazole.

In an aspect, described herein are examples of a coating composition that can include: about 5% to about 75% silyl-terminated polymers; about 20% to about 90% carrier; about 0.01% to about 10% one or more haptic additives; about 1% to about 20% crosslinker; about 0.01% to about 2% moisture cure catalyst; about 0.5% to about 5% adhesion promoter; and about 5% to about 75% inorganic filler.

In one aspect, a method of preparing a coated substrate is described. In an aspect, the substrate is metal. In an aspect, the substrate is a transportation interior, a fabric, apparel, furniture, or a leather substitute material. In an aspect, the composition provides a soft-touch coating on the substrate.

Any two or more of the features described in this specification, including in this summary section, can be combined to form implementations not specifically described herein. The details of one or more implementations are set forth in the accompanying drawings and the description below. Other features and advantages will be apparent from the description and drawings, and from the claims.

### DESCRIPTION OF THE DRAWINGS

FIG. 1 shows a Surface Insulation Resistance (SIR) measurement over time for an example coating.

FIG. 2 shows a graph of yellowness factor values for an example coating upon heating at about 175° C.

### DETAILED DESCRIPTION

The present disclosure describes compositions suitable to provide reactive moisture-cured thin (e.g., ultra-thin) coatings. Such coatings can be applied to a variety of materials and devices, for example, a non-yellowing protective coating for LED coatings, or as anti-corrosion or scratch-resistant coatings for various substrates such as glass, plastic, ceramic, and metal. The coatings described herein may provide good adhesion to various substrates, meet IPC-CC-830C specification requirements, and have minimum discoloration and transmission loss at operating temperatures of LED assemblies.

Current technologies for thin coatings are limited because they typically are formed from high cost fluoropolymers, exhibit adhesion challenges with certain substrates, and/or require mixing of two-part compositions at a certain mix ratio. Other parylene coatings require capital investment for chemical vapor deposition (CVD) processing equipment, are limited in throughput due to the restricted size of CVD chambers, and typically exhibit poor adhesion to metals.

The coatings disclosed herein can provide high electrical insulation properties including moisture insulation resistance (MIR), surface insulation resistance (SIR), and dielectric withstand voltage (DWV). The coatings can also exhibit excellent chemical resistance against various chemicals including but not limited to anti-freeze fluid, hydraulic fluid, gasoline, kerosene, and artificial sweat. The coatings also provide good flexibility and adhesion to various substrates including but not limited to FR4 printed circuit board, polyimide Kapton film, tin-plated steel, aluminum, copper, and ceramics.

The coatings disclosed herein can provide thermal stability for high operating temperature applications, for example, as high as 175° C. Further, the cured coatings retain transmission in non-yellowing properties in applications such as electrocution protective coatings for LED assemblies.

The coating compositions of the present disclosure can comprise one or more silyl-terminated polymers and one or more carriers. As used herein, the term “silyl-terminated polymer” refers to a polymer terminated by at least one silyl group. For example, the silyl-terminated polymer has at least two terminal functional groups that are silyl groups. For example, the silyl-terminated polymer is a linear polymer terminated on both ends with a silyl group. The silyl-terminated polymer may have any polymer structure, including but not limited to a linear structure, a branched structure, or a crosslinked structure.

The silyl-terminated polymer can be a homopolymer or a copolymer. For example, the silyl-terminated polymer may be a random copolymer, a block copolymer, or a graft copolymer. In some implementations, the one or more silyl-terminated polymers comprise a homopolymer. In some implementations, the one or more silyl-terminated polymers comprise a copolymer.

The composition may include any suitable silyl-terminated polymer. In some implementations, the one or more silyl-terminated polymers comprise polyurethane, polyether, polyacrylic, or combinations thereof. In some implementations, the one or more silyl-terminated polymers comprise polyurethane. In some implementations, the polyurethane comprises a silylated polyurethane resin such as SPUR+™ 3030 (Momentive Performance Materials), or a blend thereof. In some implementations, the polyurethane comprises a silane-terminated polyurethane such as Desmoseal® S (Covestro AG). In some implementations, the one or more silyl-terminated polymers comprise polyether. In some implementations, the polyether comprises a silicone-modified polyether-based silane-terminated polymer such as Geniosil® XT50 (Wacker Chemie AG), Geniosil® XB 502 (Wacker Chemie AG), or a blend thereof. In some implementations, the one or more silyl-terminated polymers comprise polyacrylic. In some implementations, the polyacrylic comprises a telechelic polyacrylate such as XMAP™ SA120S (Kaneka), or a blend thereof.

In some implementations, the one or more silyl-terminated polymers comprise polyether and polyacrylic. In some implementations, the one or more silyl-terminated polymers comprise polyurethane and polyether. In some implementations, the one or more silyl-terminated polymers comprise polyether and polyacrylic. In some implementations, a weight ratio of the polyether to the polyacrylic is from about 3:2 to about 2:3. In some implementations, a weight ratio of the polyether to the polyacrylic is about 1:1.

In some implementations, a weight ratio of the polyurethane to the polyether is from about 4:1 to about 1:1. In some implementations, a weight ratio of the polyurethane to the polyether is about 3:1. In some implementations, the one or more silyl-terminated polymers comprise a silylated polyurethane resin and a silicone-modified polyether-based silane-terminated polymer. In some implementations, a weight ratio of the silylated polyurethane resin to the silicone-modified polyether-based silane-terminated polymer is about 3:1.

In some implementations, the silyl-terminated polymer is present in the composition from about 5% to about 75% by weight. In some implementations, the silyl-terminated polymer is present in the composition from about 5% to about 50% by weight, about 5% to about 30% by weight, about 10% to about 20% by weight, about 5% to about 15% by weight, or about 10% to about 15% by weight. In some implementations, the silyl-terminated polymer is present in the composition from about 5% to about 50% by weight. In some implementations, the silyl-terminated polymer is present in the composition from about 5% to about 30% by weight. In some implementations, the silyl-terminated polymer is present in the composition from about 10% to about 20% by weight. In some implementations, the silyl-terminated polymer is present in the composition from about 5% to about 15% by weight. In some implementations, the silyl-terminated polymer is present in the composition from about 10% to about 15% by weight. In some implementations, the silyl-terminated polymer is present in the composition in about 13% by weight. In some implementations, the silyl-terminated polymer is present in the composition from about 12% to about 17% by weight. In some implementations, the silyl-terminated polymer is present in the composition in about 16% by weight.

The composition may include any suitable carrier. In some implementations, the one or more carriers comprise an organic solvent. In some implementations, the one or more carriers comprise a polar protic organic solvent. In some implementations, the one or more carriers comprise an alcohol. In some implementations, the one or more carriers comprise a C₁-C₆ alcohol. In some implementations, the one or more carriers comprise isopropyl alcohol. In some implementations, the composition comprises one carrier. For example, the carrier is isopropyl alcohol.

In some implementations, the one or more carriers comprise a ketone. Examples of suitable ketones include, but are not limited to, acetone, butanone, pentanone, hexanone, cyclopentanone, ethyl isopropyl ketone, methyl isopropyl ketone, or combinations thereof. In some implementations, the one or more carriers comprise 2-butanone.

In some implementations, the one or more carriers comprise an ester. Examples of suitable esters include, but are not limited to, methyl acetate, ethyl acetate, propyl acetate, butyl acetate, diethyl carbonate, propylene carbonate, or combinations thereof. In some implementations, the one or more carriers comprise n-butyl acetate.

In some implementations, the one or more carriers comprise a hydrocarbon solvent. Examples of suitable hydrocarbon solvents include, but are not limited to, xylene, toluene, pentane, hexane, heptane, cyclohexane, methylcyclohexane, and combinations thereof. In some implementations, the one or more carriers comprise xylene. In some implementations, the one or more carriers comprise methylcyclohexane.

In some implementations, the one or more carriers comprise xylene and cyclohexane. In some implementations, a weight ratio of xylene to methylcyclohexane is from about 3:2 to about 2:3. In some implementations, a weight ratio of xylene to methylcyclohexane is about 1:1.

In some implementations, the carrier is present in the composition from about 0.01% to about 90% by weight. In some implementations, the carrier is present in the composition from about 1% to about 90%, about 5% to about 90%, about 10% to about 90%, about 15% to about 90%, or about 1% to about 85% by weight.

In some implementations, the carrier is present in the composition from about 20% to about 90% by weight. In some implementations, the carrier is present in the composition from about 30% to about 85% by weight, about 50% to about 90% by weight, about 30% to about 80% by weight, about 75% to about 90% by weight, about 80% to about 90% by weight, or about 85% to about 90% by weight. In some implementations, the carrier is present in the composition from about 30% to about 85% by weight. In some implementations, the carrier is present in the composition from about 50% to about 90% by weight. In some implementations, the carrier is present in the composition from about 30% to about 80% by weight. In some implementations, the carrier is present in the composition from about 75% to about 90% by weight. In some implementations, the carrier is present in the composition from about 70% to about 80% by weight. In some implementations, the carrier is present in the composition from about 80% to about 90% by weight. In some implementations, the carrier is present in the composition from about 85% to about 90% by weight. In some implementations, the carrier is present in the composition in about 87% by weight. In some implementations, the carrier is present in the composition in about 84% by weight. In some implementations, the carrier is present in the composition in about 80% by weight.

In some implementations, the composition does not include a carrier.

In some implementations, the composition further comprises a moisture cure catalyst. In some implementations, the moisture cure catalyst is a tin catalyst. In some implementations, the moisture cure catalyst comprises dimethyltin neodecanoate such as Fomrez® UL28 (Galata Chemicals), or dibutyltin dilaurate such as DABCO® T-12 (Evonik). In some implementations, the moisture cure catalyst is a non-tin catalyst. In some implementations, the non-tin catalyst comprises an amine type catalyst such as dimorpholino diethyl ether, N-methoxyethoxy ethyl morpholine, N-ethyl morpholine, morpholine, triethylenediamine, n-cocomorpholine, or combinations thereof. In some implementations, the non-tin catalyst comprises a bismuth carboxylate such as K-KAT® 348 (King Industries).

In some implementations, the moisture cure catalyst is present in the composition from about 0.01 to about 2% by weight, about 0.01 to about 1% by weight, about 0.1% to about 2% by weight, or about 0.05% to about 0.1% by weight. In some implementations, the moisture cure catalyst is present in the composition from about 0.01 to about 2% by weight. In some implementations, the moisture cure catalyst is present in the composition from about 0.01 to about 1% by weight. In some implementations, the moisture cure catalyst is present in the composition from about 0.1 to about 2% by weight. In some implementations, the moisture cure catalyst is present in the composition from about 0.05 to about 1% by weight. In some implementations, the moisture cure catalyst is present in the composition in about 0.08% by weight. In some implementations, the moisture cure catalyst is present in the composition in about 0.6% by weight.

In some implementations, the composition further comprises an amine synergist. In some implementations, the amine synergist comprises 3-aminopropyltriethoxy silane. In some implementations, the amine synergist comprises Dynaslan® AMEO.

In some implementations, the amine synergist is present in the composition from about 0.01% to about 15% by weight, about 0.01% to about 2% by weight, about 0.1% to about 2% by weight, or about 0.05% to about 0.5% by weight. In some implementations, the amine synergist is present in the composition from about 0.01% to about 2% by weight. In some implementations, the amine synergist is present in the composition from about 0.1% to about 2% by weight. In some implementations, the amine synergist is present in the composition from about 0.05% to about 0.5% by weight. In some implementations, the amine synergist is present in the composition in about 0.1% by weight. In some implementations, the amine synergist is present in the composition from about 0.1% to about 1% by weight. In some implementations, the amine synergist is present in the composition in about 1% by weight. In some implementations, the composition does not include an amine synergist.

In some implementations, the composition further comprises a crosslinker. In some implementations, the crosslinker comprises tris(3-trimethoxysilylpropyl isocyanurate), tetra ethyl orthosilicate, or combinations thereof.

In some implementations, the crosslinker is present in the composition from about 0.01% to about 25% by weight. In some implementations, the crosslinker is present in the composition from about 0.01% to about 20% by weight. In some implementations, the crosslinker is present in the composition from about 0.01% to about 10% by weight, about 0.1% to about 10%, about 1% to about 10% by weight, or about 0.5% to about 5% by weight. In some implementations, the crosslinker is present in the composition from about 1% to about 20% by weight. In some implementations, the crosslinker is present in the composition from about 0.01% to about 10% by weight. In some implementations, the crosslinker is present in the composition from about 0.1% to about 10% by weight. In some implementations, the crosslinker is present in the composition from about 1% to about 10% by weight. In some implementations, the crosslinker is present in the composition from about 0.5% to about 5% by weight. In some implementations, the crosslinker is present in the composition in about 1% by weight. In some implementations, the crosslinker is present in the composition in about 2.4% by weight.

In some implementations, the crosslinker comprises tris(3-trimethoxysilylpropyl isocyanurate) and the tris(3-trimethoxysilylpropyl isocyanurate) is present in the composition in about 1% to about 25% by weight. In some implementations, the crosslinker comprises tris(3-trimethoxysilylpropyl isocyanurate) and the tris(3-trimethoxysilylpropyl isocyanurate) is present in the composition in about 1% to about 10% by weight.

In some implementations, the crosslinker comprises tetra ethyl orthosilicate and the tetra ethyl orthosilicate is present in the composition in about 0.01% to about 25% by weight. In some implementations, the crosslinker comprises tetra ethyl orthosilicate and the tetra ethyl orthosilicate is present in the composition in about 0.01% to about 10% by weight.

In some implementations, tris(3-trimethoxysilylpropyl isocyanurate) is present in the composition in about 1% to about 10% by weight, and tetra ethyl orthosilicate is present in the composition in about 0.01% to about 10% by weight.

In some implementations, the composition further comprises an adhesion promoter. In some implementations, the adhesion promoter comprises an epoxy silane. In some implementations, the adhesion promoter comprises vinyl trimethoxy silane, vinyl triethoxy silane, or combinations thereof. In some implementations, the adhesion promoter comprises vinyl trimethoxy silane such as Dynaslan® VTMO (Evonik). In some implementations, the adhesion promoter is a moisture scavenger.

In some implementations, the adhesion promoter is present in the composition from about 0.05% to about 5% by weight, about 0.5% to about 5% by weight, or about 0.1% to about 1% by weight. In some implementations, the adhesion promoter is present in the composition from about 0.05% to about 5% by weight. In some implementations, the adhesion promoter is present in the composition from about 0.5% to about 5% by weight. In some implementations, the adhesion promoter is present in the composition from about 0.1% to about 1% by weight. In some implementations, the adhesion promoter is present in the composition in about 0.5% by weight.

Without wishing to be bound by theory, the compositions incorporating crosslinking agent and adhesion promoter into the coating can provide a tightly meshed, crosslinked network of hybrid organo-silicone polymer, which can result in both good chemical resistance and adhesion.

In some implementations, the composition further comprises a wetting agent. Any suitable wetting agent may be used. In some implementations, the wetting agent comprises a polyether siloxane copolymer such as Tego® Wet 270 (Evonik), a polyether-modified polydimethylsiloxane such as BYK® 301 (BYK), or a combination thereof. In some implementations, the composition from about 0.5% to about 5% by weight, about 1% to about 5% by weight, about 1% to about 3% by weight, or about 1% to about 2% by weight. In some implementations, the composition from about 1% to about 5% by weight. In some implementations, the wetting agent is present in the composition in about 1.5% by weight. In some implementations, the wetting agent improves the coating wetting properties on low surface energy substrates. In some implementations, the composition does not include a wetting agent.

In some implementations, the composition further comprises an optical brightener. The optical brightener acts as a UV tracer and can ease inspection of the coated assemblies using a black light. In some implementations, the optical brightener comprises 2,5-thiophenediylbis(5-tert-butyl-1,3-benzoxazole) such as Uvitex® OB. In some implementations, the optical brightener is present in the composition from about 0.01% to about 1% by weight, or about 0.01% to about 0.5% by weight. In some implementations, the optical brightener is present in the composition in about 0.1% by weight.

In some implementations, the composition does not comprise optical brightener. For example, compositions used for LEDs may not include optical brightener to provide non-yellowing characteristics during the operation of the LED.

In some implementations, the composition further comprises one or more inorganic fillers. In some implementations, the one or more inorganic fillers are present in the composition from about 0.01% to about 75% by weight. In some implementations, the one or more inorganic fillers are present in the composition from about 0.01% to about 50% by weight. In some implementations, the one or more inorganic fillers are present in the composition from about 5% to about 75% by weight. In some implementations, the one or more inorganic fillers are present in the composition from about 5% to about 25%, about 25% to about 50%, about 50% to about 75%, about 5% to about 50%, or about 10% to about 40% by weight.

Any suitable inorganic filler may be used. Examples of suitable inorganic fillers include but are not limited to calcium carbonate, aluminum silicate, alumina, talc, silica, or combinations thereof. In some implementations, the one or more inorganic fillers include a compound comprising aluminum, calcium, magnesium, silicon, or combinations thereof. In some implementations, the one or more inorganic fillers comprise a metal oxide, a silicate, or combinations thereof.

In some implementations, the one or more inorganic fillers comprise one or more inorganic toughening and ruggedization agents. In some implementations, the inorganic toughening and ruggedization agents, when included in the coating composition, improve at least one of toughness, abrasion resistance, and scratch resistance of a coating prepared from the composition. Examples of inorganic toughening and ruggedization agents include, but are not limited to, metal oxides, silicates, aluminates, glass beads, nano-spheres, and combinations thereof. In some implementations, the inorganic toughening and ruggedization agents comprise zinc oxide, fumed silica, aluminum oxide, silica, polymeric nano-spheres, or a combination thereof. In some implementations, the one or more inorganic toughening and ruggedization agents have a particle size between from about 1 nm to about 10 μm. In some implementations, the one or more inorganic toughening and ruggedization agents are present in the composition from about 5% to about 75% by weight. In some implementations, the one or more inorganic toughening and ruggedization agents are present in the composition from about 5% to about 25%, about 25% to about 50%, about 50% to about 75%, about 5% to about 50%, or about 10% to about 40% by weight.

In some implementations, the one or more inorganic fillers comprise one or more scratch resistance additives. Examples of scratch resistance additives include, but are not limited to, metal oxides, montmorillonite clay, and nano-silica. In some implementations, the one or more scratch resistance additives comprise a metal oxide. In some implementations, the one or more scratch resistance additives comprise aluminum oxide, zinc oxide, zirconium oxide, or a combination thereof. In some implementations, the one or more scratch resistance additives are present in the composition from about 5% to about 75% by weight. In some implementations, the one or more scratch resistance additives are present in the composition from about 5% to about 25%, about 25% to about 50%, about 50% to about 75%, about 5% to about 50%, or about 10% to about 40% by weight.

In some implementations, the one or more inorganic fillers comprise one or more rheology modifiers. Examples of rheology modifiers include, but are not limited to, clay, silica, and chalk. In some implementations, the one or more rheology modifiers comprise clay, silica, chalk, or a combination thereof. In some implementations, the one or more rheology modifiers are present in the composition from about 0.01% to about 25% by weight. In some implementations, the one or more scratch resistance additives are present in the composition from about 5% to about 25%, about 10% to about 25%, about 1% to about 10%, about 15% to about 25%, or about 1% to about 5% by weight.

In some implementations, the composition further comprises one or more bulking agents. In some implementations, the one or more bulking agents increase the volume of the coating prepared from the composition. In some implementations, the one or more bulking agents increase the volume of the coating without using high cost ingredients. In some implementations, the one or more bulking agents are present in the composition from about 0.01% to about 75% by weight. In some implementations, the one or more bulking agents are present in the composition from about 0.01% to about 30% by weight. In some implementations, the one or more bulking agents are present in the composition from about 5% to about 75% by weight. In some implementations, the one or more bulking agents are present in the composition from about 5% to about 25%, about 25% to about 50%, about 50% to about 75%, about 5% to about 50%, or about 10% to about 40% by weight.

Any suitable bulking agent may be used. Examples of suitable bulking agents include but are not limited to hollow glass beads and Dualite® polymeric microspheres. In some implementations, the one or more bulking agents comprise a metal oxide, a silicate, an aluminate, glass beads, nano-spheres, nano clay or combinations thereof. In some implementations, the one or more bulking agents comprise a metal oxide, a silicate, or combinations thereof. In some implementations, the one or more bulking agents have a particle size between from about 1 nm to about 10 μm.

In some implementations, the composition further comprises one or more thixotropic agents. In some implementations, the one or more thixotropic agents are present in the composition from about 0.01% to about 25% by weight. In some implementations, the one or more thixotropic agents are present in the composition from about 0.01% to about 10% by weight. In some implementations, the one or more thixotropic agents are present in the composition from about 1% to about 5%, about 0.5 to about 2%, about 10% to about 25%, or about 1% to about 10% by weight. Any suitable thixotropic agent may be used. Examples of suitable thixotropic agents include but are not limited to hydroxypropyl methylcellulose, hydroxyethyl cellulose, and polyacrylic acid. In some implementations, the one or more thixotropic agents comprise polyurea, hydroxypropyl methylcellulose, hydroxyethyl cellulose, or a combination thereof.

In some implementations, the composition further includes one or more UV stabilizers. In some implementations, the one or more UV stabilizers are present in the composition from about 0.01% to about 10% by weight. In some implementations, the one or more UV stabilizers are present in the composition from about 0.01% to about 5%, or about 0.5% to about 2% by weight. In some implementations, the one or more UV stabilizers comprise a hindered amine light stabilizer, a benzotriazole, or a combination thereof. In some implementations, the one or more UV stabilizers comprise a hindered amine light stabilizer. In some implementations, the one or more UV stabilizers comprise a hindered amine light stabilizer and a benzotriazole. In some implementations, the one or more UV stabilizers comprise a hindered amine light stabilizer and a 2-(2-hydroxyphenyl)-benzotriazole such as Tinuvin® 5050 (BASF).

In some implementations, the composition further includes one or more anti-corrosion additives. In some implementations, the one or more anti-corrosion additives are present in the composition from about 0.01% to about 15% by weight. In some implementations, the one or more anti-corrosion additives are present in the composition from about 0.1% to about 15% by weight. In some implementations, the one or more anti-corrosion additives are present in the composition from about 0.1% to about 5%, about 0.5% to about 2%, or about 1% to about 10% by weight. In some implementations, the one or more anti-corrosion additives comprise a metal, an inorganic compound (e.g., a metal phosphate or a metal oxide), or an organic compound (e.g., carbamates, benzotriazoles). In some implementations, the one or more anti-corrosion additives comprise zinc, zinc phosphate, cerium oxide, a carbamate, a benzotriazole, or a combination thereof.

In some implementations, the composition further includes one or more anti-oxidants. In some implementations, the one or more anti-oxidants are present in the composition from about 0.01% to about 15% by weight. In some implementations, the one or more anti-oxidants are present in the composition from about 0.01% to about 5%, about 0.5% to about 2%, or about 1% to about 10% by weight. In some implementations, the one or more anti-oxidants comprise an inorganic anti-oxidant, an organic anti-oxidant, or a combination thereof. In some implementations, the one or more anti-oxidants comprise a hindered amine light stabilizer, a carbamate, a benzotriazole, or a combination thereof.

In some implementations, the composition further includes one or more haptic additives. In some implementations, the one or more haptic additives are present in the composition from about 0.01% to about 10% by weight. In some implementations, the one or more haptic additives are present in the composition from about 0.01% to about 5%, about 0.5% to about 5%, about 0.1% to about 2%, or about 1% to about 10% by weight. Examples of suitable haptic additives include but are not limited to silicones such as Dowsil™ (Dow) and ureas such as Pergopak® (Huber Advanced Materials). In some implementations, the one or more haptic additives comprise a polymer, a wax, or a combination thereof. In some implementations, the one or more haptic additives comprise a micronized wax, a silicone polymer, a polyurea polymer, or a combination thereof.

In some implementations, the one or more haptic additives provide soft touch properties to a coating prepared from the coating composition. In some implementations, the composition provides soft touch properties to a coating prepared from the coating composition without including a haptic additive.

In some implementations, the composition is substantially free from fluorochemicals, for example, fluoropolymers. In some implementations, the composition comprises less than 1% fluorochemicals by weight, less than 0.5% fluorochemicals by weight, less than 0.1% fluorochemicals by weight, or less than 0.01% fluorochemicals by weight.

In some implementations, the composition is a one-part composition. A one-part composition includes all of the components of the composition in one part. In some implementations, the one-part composition comprises the one or more silyl-terminated polymers, one or more carriers, and a moisture cure catalyst. In some implementations, the one-part composition further comprises one or more of an amine synergist, a crosslinker, an adhesion promoter, and a wetting agent. In some implementations, the one-part composition further comprises an optical brightener.

In some implementations, the composition is a two-part composition having a first-part component and a second-part component. In some implementations, the first-part component comprising the one or more silyl-terminated polymers in one or more carriers, and the second-part component comprising the moisture cure catalyst in one or more carriers. In some implementations, the second-part component further comprises water. In some implementations, the second-part component further comprises one or more of an amine synergist, a crosslinker, an adhesion promoter, and a wetting agent. In some implementations, the second-part component further comprises an optical brightener. The coating compositions provided herein may be suitable for curing at an ambient temperature or at an elevated temperature. In some implementations, the coating composition is suitable for curing at an ambient temperature. Curing the coating at an ambient temperature can be advantageous, for example, by saving energy costs and eliminating the need for a heating oven. In some implementations, the ambient temperature is in a range of from about 15° C. to about 25° C., or about 20° C. to about 24° C. In some implementations, the elevated temperature is a temperature above ambient temperature.

In some implementations, the coating composition is suitable for curing at an elevated temperature. In some implementations, the elevated temperature is in a range of from about 26° C. to about 80° C.

In some implementations, the composition comprises:
about 5% to about 50% silyl-terminated polymer;
about 30% to about 90% carrier;
about 0.01% to about 2% moisture cure catalyst;
about 0.01% to about 2% amine synergist;
about 0.1% to about 10% crosslinker;
about 0.05% to about 5% adhesion promoter; and
about 0.5% to about 5% wetting agent.

In some implementations, the composition comprises:
about 5% to about 30% silyl-terminated polymer;
about 75% to about 90% carrier;
about 0.01% to about 1% moisture cure catalyst;
about 0.05% to about 0.5% amine synergist;
about 0.5% to about 5% crosslinker;
about 0.1% to about 1% adhesion promoter; and
about 1% to about 3% wetting agent.

In some implementations, the composition comprises:
about 5% to about 50% silyl-terminated polymer;
about 30% to about 90% carrier;
about 0.01% to about 2% moisture cure catalyst;
about 0.01% to about 2% amine synergist; and
about 0.1% to about 10% crosslinker.

In some implementations, the composition comprises:
about 5% to about 30% silyl-terminated polymer;
about 75% to about 90% carrier;
about 0.01% to about 1% moisture cure catalyst;
about 0.1% to about 2% amine synergist; and
about 0.5% to about 5% crosslinker.

In some implementations, the coating composition comprises:
about 5% to about 75% by weight silyl-terminated polymers;
about 20% to about 90% by weight carrier;
about 1% to about 20% crosslinker;
about 0.01% to about 2% moisture cure catalyst;
about 0.5% to about 5% adhesion promoter; and
about 5% to about 75% inorganic filler.

In some implementations, the coating composition comprises:
about 5% to about 30% by weight silyl-terminated polymers;
about 70% to about 90% by weight carrier;
about 1% to about 10% crosslinker;
about 0.01% to about 2% moisture cure catalyst;
about 0.5% to about 5% adhesion promoter; and
about 5% to about 50% inorganic filler.

In the coating compositions described herein, % refers to % by weight (i.e., percent weight of the total weight of the coating composition), unless specifically stated otherwise.

Also provided herein is a coating composition comprising one or more silyl-terminated polymers, one or more carriers, and one or more inorganic fillers, wherein:
the silyl-terminated polymer is present in the composition from about 5% to about 75% by weight;
the carrier is present in the composition from about 20% to about 90% by weight; and
the one or more inorganic fillers are present in the composition from about 5% to about 75% by weight; and
the coating composition is suitable to provide a coating having a thickness of less than about 130 microns.

In some implementations, the coating composition comprises:
about 5% to about 75% by weight silyl-terminated polymers;
about 20% to about 90% by weight carrier; and
about 5% to about 75% inorganic toughening and ruggedization agents.

Also provided herein is a coating composition comprising one or more silyl-terminated polymers, one or more carriers, and one or more anti-corrosion additives, wherein:
the silyl-terminated polymer is present in the composition from about 5% to about 75% by weight;
the carrier is present in the composition from about 20% to about 90% by weight; and
the one or more anti-corrosion additives are present in the composition from about 0.1% to about 15% by weight; and
the coating composition is suitable to provide a coating having a thickness of less than about 130 microns.

In some implementations, the coating composition comprises:
about 5% to about 75% by weight silyl-terminated polymers;
about 20% to about 90% by weight carrier;
about 0.1% to about 15% of the one or more anti-corrosion additives;
about 1% to about 20% crosslinker;
about 0.01% to about 2% moisture cure catalyst;
about 0.5% to about 5% adhesion promoter; and
about 5% to about 75% inorganic filler.

Also provided herein is a coating composition comprising one or more silyl-terminated polymers, one or more carriers, and one or more haptic additives, wherein:
the silyl-terminated polymer is present in the composition from about 5% to about 75% by weight;
the carrier is present in the composition from about 20% to about 90% by weight; and
the one or more haptic additives are present in the composition from about 0.01% to about 10% by weight; and
the coating composition is suitable to provide a coating having a thickness of less than about 130 microns.

In some implementations, the coating composition comprises:
about 5% to about 75% by weight silyl-terminated polymers;
about 20% to about 90% by weight carrier;
about 0.01% to about 10% of the one or more haptic additives;
about 1% to about 20% crosslinker;
about 0.01% to about 2% moisture cure catalyst;
about 0.5% to about 5% adhesion promoter; and
about 5% to about 75% inorganic filler.

In some implementations, provided herein is a coating composition comprising:
about 5% to about 75% by weight silyl-terminated polymers; and
one or more of a carrier, a crosslinker, a moisture cure catalyst, an adhesion promoter, an inorganic filler, a bulking agent, a thixotropic agent, an inorganic toughening and ruggedization agent, an anti-corrosion additive, an anti-oxidant, a haptic additive, a UV stabilizer, a scratch resistance additive, and a rheology modifier.

In some implementations, provided herein is a coating composition comprising:
about 5% to about 75% by weight silyl-terminated polymers;
about 20% to about 90% by weight carrier;
about 1% to about 20% crosslinker;
about 0.01% to about 2% moisture cure catalyst;
about 0.5% to about 5% adhesion promoter;
about 5% to about 75% of one or more inorganic toughening and ruggedization agents;
about 5% to about 75% of one or more bulking agents;
about 0.01% to about 25% one ore more thixotropic agents;
about 0.01% to about 15% of one or more anti-corrosion additives;
about 0.01% to about 15% anti-oxidants;
about 0.01% to about 10% of one or more haptic additives;
about 0.01% to about 10% UV stabilizer;
about 0.01% to about 10% one or more scratch resistance additives; and
   about 0.01% to about 10% one or more rheology modifiers. In some implementations, the coating composition is suitable to provide a coating having a thickness of less than about 130 microns. In some implementations, the coating has a thickness of less than about 100 microns, less than about 50 microns, less than about 25 microns, less than about 15 microns, or less than about 12.5 microns. In some implementations, the coating composition is suitable to provide a coating having a thickness of less than about 12.5 microns. In some implementations, the coating composition is suitable to provide a coating having a thickness of less than about 12 microns. In some implementations, the coating composition is suitable to provide a coating having a thickness in a range of from about 0.5 microns to about 12.5 microns.

The Institute for Interconnecting and Packaging Electronic Circuits (IPC) has recognized a class of electrical insulating coatings for electronic assemblies under the classification of UT (ultra-thin) type with a maximum thickness of 12.5 microns. In some implementations, the coating composition is suitable to provide an ultra-thin coating as classified by the IPC.

In some implementations, the coating composition provides a waterproof coating. In some implementations, the coating substantially conforms to IPX7 waterproof standards of the International Electrochemical Commission.

In some implementations, the coating composition provides a coating that is resistant against degradation from chemicals and/or sweat. In some implementations, the coating is resistant against anti-freeze fluid, hydraulic fluid, gasoline, kerosene, and/or artificial sweat. In some implementations, the coating has no discoloration, change in gloss, blistering, softening, swelling, and/or loss of adhesion after being exposed to chemicals in a chemical resistance test according to ASTM D-2792. In some implementations, the coating is exposed to chemicals for a period of at least 24 hours.

In some implementations, the coating is resistant against sweat. In some implementations, the coating has a current leakage of about 0.1 μA to about 2 μA after being immersed in an artificial sweat solution with an applied electrical power of about 9V. In some implementations, the coating has a current leakage of less than about 0.7 μA after being immersed in an artificial sweat solution with an applied electrical power of about 9V. In some implementations, the artificial sweat solution comprises about 1 g of urea, about 0.5 g of ammonium chloride, about 1 g of lactic acid, and about 1 L of water. In some implementations, the coating is immersed in the artificial sweat solution for about 30 hours.

In some implementations, the coating composition provides a coating having good adhesion to various materials. In some implementations, the coating provides adhesion to one or more materials selected from glass, plastic, ceramics, FR4, polyimide, metal, and a metal alloy. In some implementations, the coating provides adhesion to materials selected from FR4, polyimide, ceramics, copper, and tin-plated steel. In some implementations, the coating provides adhesion to FR4 printed circuit board. In some implementations, the coating provides adhesion to polyimide. In some implementations, the polyimide is a Kapton film. In some implementations, the coating provides adhesion to ceramics. In some implementations, the coating provides adhesion to a metal or a metal alloy. In some implementations, the metal is copper, tin, or steel. In some implementations, the coating provides adhesion to copper. In some implementations, the coating provides adhesion to tin-plated steel.

In some implementations, the coating composition provides a coating having good electrical insulation properties. In some implementations, the coating has a surface insulation resistance (SIR) value of above about 1 GΩ. In some implementations, the coating has a SIR value of above about 1 GΩ after more than about 20 hours, about 40 hours, about 60 hours, about 80 hours, about 100 hours, about 120 hours, about 140 hours, or about 160 hours. For example, the coating has a SIR value of above about 1 GΩ after about 168 hours.

In some implementations, the coating is resistant against moisture having a moisture insulation resistance (MIR) value above about 5 GΩ. In some implementations, the coating is resistant against moisture having a MIR value above about 25 GΩ, about 50 GΩ, about 75 GΩ, about 100 GΩ, about 125 GΩ, about 150 GΩ, or about 165 GΩ. In some implementations, the coating has the MIR value after one, two, three, four, five, six, seven, eight, nine, or ten temperature humidity cycles. In some implementations, the temperature humidity cycle is from 25° C. at 90% RH to 65° C. at 90% RH. In some implementations, the coating has the MIR value after one, two, three, four, five, six, seven, eight, nine, or ten 50V DC cycles.

In some implementations, the coating has a current leakage of less than about 10 μA, less than about 5 μA, less than about 1 μA, less than about 0.5 μA, or less than about 0.1 μA as measured in a Dielectric Withstand Voltage test according to IPC-TM-650 2.5.7.1.

In some implementations, the coating composition provides a coating that is resistant to yellowing. In some implementations, the coating has a yellowness factor (b*) of below about 0.75, below about 0.5, below about 0.4, or below about 0.3 after heating at about 175° C. In some implementations, the coating has a yellowness factor (b*) of below about 0.3 after heating at about 175° C. In some implementations, the heating is for more than about 1 day, more than about 7 days, or more than about 14 days.

In some implementations, the coating composition provides a coating that is resistant to thermal shock. In some implementations, the coating is resistant to thermal shock having no bubbles, cracking, delamination, and/or blistering after more than about 10 cycles, about 20 cycles, about 30 cycles, about 40 cycles, about 50 cycles, about 60 cycles, about 70 cycles, about 80 cycles, about 90 cycles, or about 100 cycles. The cycles may be between any two suitable temperatures. In some implementations, the cycles were carried out between about −65° C. to about 125° C.

In some implementations, the coating composition provides a coating with good flexibility. In some implementations, the coating is resistant to cracking and/or crazing when bent about 90°, about 120°, about 150°, or about 180° using a mandrel tester. For example, the coating is resistant to cracking and crazing when bent about 180° using a mandrel tester.

In some implementations, the coating composition provides a coating that is resistant to thermal humidity aging. In some implementations, the coating is resistant to thermal humidity aging having no discoloration, cracking, and/or delamination after being exposed to a humidity chamber. In some implementations, the humidity chamber is at about 85° C. and about 95% relative humidity (RH). In some implementations, the coating is exposed to the humidity chamber for more than about 30 days, more than about 60 days, more than about 90 days, or more than about 120 days.

In some implementations, the coating composition provides a coating that is flame-retardant. In some implementations, the coating meets the minimum horizontal burning test standard as carried out according to a UL94 Flammability test.

In some implementations, the coating composition provides a coating that is resistant to biological growth. In some implementations, the coating does not have biological growth in a fungus resistance test according to IPC-TM-650 2.6.1.1. In some implementations, the coating is exposed to fungus for a duration of about 28 days.

In some implementations, the coating substantially conforms to Institute for Interconnecting and Packaging Electronic Circuits (IPC) requirements for an Ultra-Thin (UT) type coating according to IPC-CC-830C specification.

In some implementations, the composition comprises one or more silyl-terminated polymers and one or more carriers, wherein:
the coating composition is suitable to provide a coating having a thickness of less than about 12.5 microns;
the coating substantially conforms to IPX7 waterproof standards of the International Electrochemical Commission;
the coating has no discoloration, change in gloss, blistering, softening, swelling, and/or loss of adhesion after being exposed to chemicals in a chemical resistance test according to ASTM D-2792; and
the coating provides adhesion to materials selected from FR4, polyimide, ceramics, copper, and tin-plated steel.

In some implementations, the composition comprises one or more silyl-terminated polymers and one or more carriers, wherein:
the coating composition is suitable to provide a coating having a thickness of less than about 12.5 microns;
the coating substantially conforms to IPX7 waterproof standards of the International Electrochemical Commission;
the coating has no discoloration, change in gloss, blistering, softening, swelling, and/or loss of adhesion after being exposed to chemicals in a chemical resistance test according to ASTM D-2792;
the coating has a current leakage of less than about 0.7 μA after being immersed in an artificial sweat solution with an applied electrical power of about 9V;
the coating provides adhesion to materials selected from FR4, polyimide, ceramics, copper, and tin-plated steel;
the coating has a SIR value of above about 1 GΩ after more than about 20 hours;
the coating is resistant against moisture having a MIR value above about 5 GΩ;
the coating has a yellowness factor (b*) of below about 0.4 after heating at about (175° C.);
the coating is resistant to thermal shock having no bubbles, cracking, delamination, or blistering after more than about 10 cycles; and
the coating is resistant to cracking and/or crazing when bent about 90° using a mandrel tester.

In some implementations, the coating composition provides a coating that is impact resistant. In some implementations, the coating is resistant to mechanical impact according to ASTM D-2794.

In some implementations, the coating composition provides a coating that is scratch resistant. In some implementations, the coating is scratch resistant according to ASTM D-7027.

In some implementations, the coating composition provides a coating that is anti-corrosive. In some implementations, the coating composition that prevents at least one of corrosion, oxidation, rusting, and tarnishing of metal surfaces. In some implementations, the coating is anti-corrosive according to ASTM B117. In some implementations, the coating is anti-corrosive according to MIL PRF16173E.

In some implementations, the coating composition provides a haptic coating or a soft-touch coating. In some implementations, the coating has a Shore A hardness of from 10 to 80. The coating hardness can be determined using a durometer.

In some implementations, the coating has a coefficient of friction of from about 0.1 to about 0.9. In some implementations, the coefficient of friction is measured according to ASTM D-1894.

In some implementations, the coating has a plastic softening temperature of between about 10° C. and 40° C. In some implementations, the plastic softening temperature is measured according to ASTM D-1525.

In some implementations, the coating has a modulus of between about 1 MPa and about 10 MPa. In some implementations, the modulus is measured according to ASTM D-412.

A coating can be prepared using the compositions described herein. An example method of preparing a coating is described below, comprising:
(a) preparing a mixture comprising the one or more silyl-terminated polymers and the one or more carriers; and
(b) stirring the mixture.

In some implementations, the mixture further comprises one or more of an adhesion promoter, a crosslinker, an amine synergist, a moisture cure catalyst, a wetting agent, and an optical brightener. In some implementations, the mixture further comprises an adhesion promoter, a crosslinker, an amine synergist, a moisture cure catalyst, and a wetting agent. In some implementations, the mixture further comprises an optical brightener. Any order of addition of the components may be used to prepare the mixture.

In some implementations, the stirring is performed under an inert atmosphere. In some implementations, the inert atmosphere is a nitrogen or argon atmosphere. In some implementations, the inert atmosphere is a nitrogen atmosphere.

A coated substrate can be prepared using the compositions provided herein. An example method of preparing a coated substrate is described below, comprising:
(a) applying a coating composition provided herein to a substrate; and
(b) curing the coating composition.

In some implementations, the curing is performed at a temperature in a range from about 15° C. to about 80° C.

Another example method of preparing a coated substrate is described below, comprising:
(a) applying a coating composition provided herein to a substrate; and
(b) curing the coating composition at an ambient temperature.

In some implementations, the applying comprises dip-coating, brushing, or spraying the coating composition. In some implementations, the composition does not utilize heat to cure the coating. In some implementations, the curing comprises evaporating the one or more carriers. In some implementations, the curing comprises evaporating the one or more carriers and exposing the coating composition to moisture. In some implementations, the curing comprises moisture-induced hydrolysis, wherein exposing the coating composition to moisture can activate a chemical reaction of the silyl groups in the composition to cure the coating composition. In some implementations, the moisture comprises liquid water, water vapor, or a gas comprising water vapor, such as air.

In some implementations, the substrate is an electrical device or medical device.

In some implementations, the composition is applied to the substrate to provide a coating having anti-corrosive properties. In some implementations, the substrate is a metal substrate. In some implementations, the substrate is a storage container or a shipping container.

In some implementations, the substrate is a pipeline. In some implementations, the pipeline is a water pipeline, an oil and/or gas pipeline, or a chemical containment pipeline. In some implementations, the composition is coated on an inner surface and/or and outer surface of a pipeline. In some implementations, the pipeline is a metal pipeline (e.g., a steel pipeline).

In some implementations, the composition is a haptic coating. In some implementations, the substrate is a transportation interior (e.g., automotive, bus, and airplane interiors), a fabric, apparel (e.g., garments, accessories such as handbags, luggage), furniture, or a leather substitute material. In some implementations, the composition is applied to a substrate to provide a soft-touch coating on the substrate. In some implementations, the haptic coating provides improved feel and wear resistance on the surface of the substrate.

In some implementations, the substrate is concrete or rock.

In some implementations, the substrate is glass or plastic. In some implementations, the substrate is glass. In some implementations, the substrate is plastic. In some implementations, the compositions is applied to the substrate to provide a coating that provides protection and ruggedization of the substrate.

An apparatus comprising the coating composition can be prepared according to the methods and compositions disclosed herein. In some implementations, the apparatus is an electrical device or a medical device. In some implementations, the electrical device is an electronic component, a light-emitting diode (LED), an electronic circuit board, an electronic assembly, consumer electronics, a control module, an electronic sensor, or an electronic detector. In some implementations, the electronic assembly is a flexible electronic assembly. In some implementations, the electronic assembly is a rigid electronic assembly. In some implementations, the electronic circuit board is an electronic printed circuit board. In some implementations, the electronic printed circuit board comprises hardware that controls the flow of electrical energy to process information or control a system. In some implementations, the coating is an electrocution protective coating for an LED. In some implementations, the LED is for aerospace, automotive (e.g., headlights), street, indoor, signage, or accent/mood lighting applications.

In some implementations, the electrical device is an LED. In some implementations, the LED is able to withstand being lit upon immersion in water at an applied electrical power of about 9V. In some implementations, the LED is immersed for a period of about 24 hours, about 48 hours, or about 72 hours. In some implementations, the LED is immersed for about 72 hours.

In some implementations, the medical device is a hearing device, a sight assist device, a neurostimulation device, a cardiostimulation device, a stent, a cable assembly, a probe, or a catheter. In some implementations the medical device is a handheld device, a wearable device, or a fluid contact surface.

Also provided herein is a surface of a material coated with a coating composition described herein.

### EXAMPLES

### General Testing Procedures

Typical Quality Control (QC) properties such as viscosity, percent solids, density, appearance, and fluorescence check using a black light are checked.

The viscosity of the manufactured coating (e.g., ultra-thin coating) is measured per ASTM D-1084 using a Brookfield viscometer at 25° C. using a small sample adaptor set up with SC4-18 spindle at 60 rpm.

The density of manufactured coating (e.g., ultra-thin coating) is measured per ASTM D-1475. The percent non-volatiles of the coating is measured per Fed Std-141 method 4044. The appearance of coating is determined visually.

### IPC-CC-830 C Testing

### Thermal Humidity Aging (THA) Per IPC-TM-650 Method 2.6.11.1

The THA test boards are prepared from MIL Y coupons coated with the manufactured coating (e.g., ultra-thin coating) and cured at ambient temperature overnight before being placed in a humidity chamber at 85° C. and 95% RH for 120 days. The test boards are examined every 28 days for sign of any discoloration, cracking, and delamination.

### Thermal Shock Per IPC-TM-650 Method 2.6.7.1 (100 Cycles Between −65° C. And 125° C.

The thermal shock test boards are coated with coating (e.g., ultra-thin coating) and cured at ambient temperature overnight prior to the testing. The thermal shock test boards are examined for any sign of bubbles, cracking, delamination and blistering at completion of the test for 100 cycles between −65° C. and 125° C.

### Moisture Insulation Resistance (MIR) Per IPC-TM-650 Method 2.6.3.4

The MIR IPC-25-A test boards are coated with coating (e.g., ultra-thin coating) and cured at ambient temperature overnight before being conditioned for the testing at 50° C. ambient humidity for a period of 24 hours. A megohmmeter is used in measuring the insulation resistance at certain intervals of temperatures relative humidity cycling under 50V DC bias per test method procedure.

### Dielectric Withstand Voltage (DWV) per IPC-TM-650 2.5.7.1

The DWV test boards are coated with coating (e.g., ultra-thin coating) and cured at ambient temperature overnight prior to the testing.

### Flammability per UL94

The FR4 flame stripes are coated with coating (e.g., ultra-thin coating) and cured at ambient temperature overnight prior to the testing per UL94 test method.

### Flexibility Per IPC-TM-650 3.4.5.1

The Q panels are coated with coating (e.g., ultra-thin coating) and cured at ambient temperature overnight prior to the flexibility test using mandrel tester.

### Fungus Test Per IPC-TM-650 2.6.1.1

The fungus test boards are coated with coating (e.g., ultra-thin coating) and cured at ambient temperature overnight prior and were sent to an outside lab for fungus test at duration of 28 days per test method.

### Surface Insulation Resistance (SIR) per IPC-J-STD-004 (IPC-TM-650 2.6.3.3)

The SIR IPC-B-24 test boards are coated with coating (e.g., ultra-thin coating) and cured at ambient temperature overnight prior to the testing. A megohmmeter is used in measuring the surface insulation resistance per test procedure in 7 days time span per test method.

### Chemical Resistance Test Adopted Per ASTM D-2792

The coating (e.g., ultra-thin coating) is applied to tin plated steel panels and cured overnight at ambient condition. The coated test panels are immersed in the test liquid and the vessel is covered for a period of 24 hours, The test panels are then removed and being examined for defects such as discoloration, change in gloss, blistering, softening, swelling, and loss of adhesion.

### Transmission and Yellowness Factor Per ASTM E313

The glass slides are coated with coating (e.g., ultra-thin coating) and tested after overnight curing at ambient conditions. CM-5 spectrophotometer (Konica Minolta) is used for transmission and yellowness factor (b*) measurements of tested coatings as cured and after any heat treatment.

### Water and Artificial Sweat Immersion Test Per IPX7

The water immersion test is done based on IPX7 test standard established by International Electrochemical Commission (IEC). The test boards are coated with coating (e.g., ultra-thin coating) and tested after overnight curing at ambient condition. The test boards are immersed in a water or artificial sweat reservoir and connected to a potentiostat in conjunction with an impedance analyzer. The voltage of 9 Volts is being applied to the test boards. The current leakage across the test board is then measured as a function of time. The artificial sweat solution compromises 1 g of urea, 0.5 g of ammonium chloride and 1 g of lactic acid dissolved in 1 L of water.

### Example 1: Preparation of an Ultra-Thin Coating for Electronics Application

The mixing vessel was charged with 13 grams of silyl modified resin such as SPUR+™ 3030, 1 gram of tris [3-(trimethoxysilyl) propyl] isocyanurate, 0.5 grams Dynasylan® VTMO, 0.1 g of Uvitex® OB (as UV tracer), and 53.72 grams of isopropyl alcohol (IPA). The mixture was stirred for 20 minutes using a mechanical stirrer under nitrogen atmosphere to form a clear liquid. A solution of 0.1 g of Dynasylan® AMEO and 0.08 grams of Fomrez® UL 28 in 30 grams of IPA was then added, and the mixture was stirred for an additional minute under nitrogen atmosphere. Finally, 1 g of Tego® Wet 270 and 0.5 g of BYK 301 are added, and the mixture is stirred for another 5 minutes under nitrogen atmosphere to produce a clear, colorless low viscosity liquid.

### Example 2: Preparation of an Ultra-Thin Coating for LED Application

The coating was prepared using the same process as described in Example 1, excluding Uvitex® OB from the formulation.

### Example 3: Preparation of an Ultra-Thin Coating for Electronics and LED Applications

The mixing vessel was charged with 40 grams of xylene, 40 grams of methylcyclohexane, 0.96 g of Dynasylan® AMEO, 8 grams of silyl modified resin such as SPUR+™ 3030, 8 grams of silyl modified resin GenioSil® XT50, 0.32 gram of tris [3-(trimethoxysilyl) propyl] isocyanurate, 2.08 grams of tetraethyl orthosilicate, and 0.64 grams of Fomrez® UL 28. The mixture was stirred for 10 minutes using a mechanical stirrer to form a clear liquid.

### Surface Insulation Resistance Measurement

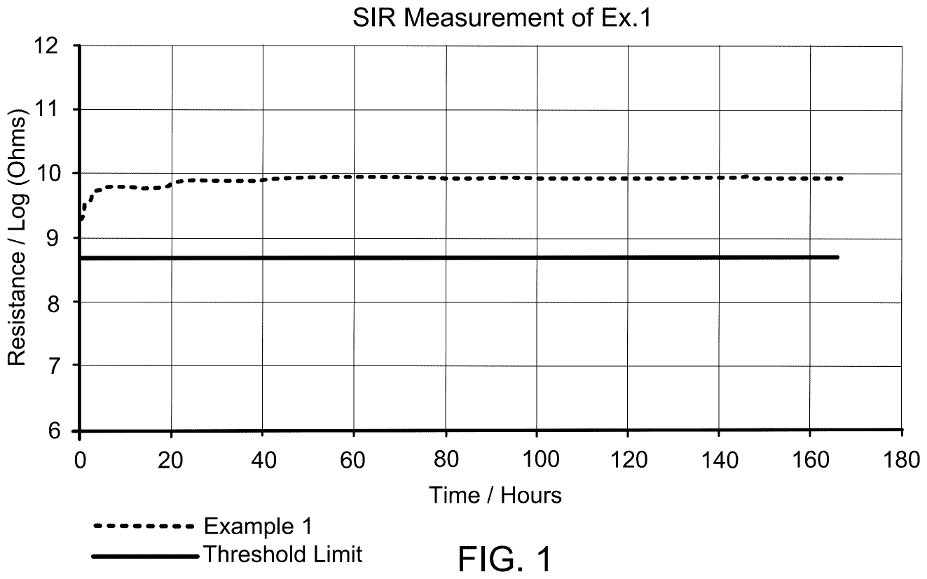

FIG. 1 shows a graph of a Surface Insulation Resistance (SIR) measurement of the coating of Example 1. As can be seen from the graph, the coating displayed a high SIR value of over 9 log (ohms), corresponding to 1 GigaOhm, for a period of 168 hours.

### Moisture Insulation Resistance (MIR) and Dielectric Withstand Voltage (DWV) Measurements

Table 1 shows MIR and DWV measurements for the coating of Example 1. Samples 1-4 were tetraplicate measurements of the coating of Example 1, where the electrical response was measured under the same conditions.

TABLE 1

| | | | | | | IR | |
|---|---|---|---|---|---|---|---|
| | | | | | | After | DWV |
| | Initial | ^{1s}t | 4^{th} | 7^{th} | 10^{th} | MIR | (leakage |
| Sample | (TΩ) | Cycle (GΩ) | cycle (GΩ) | cycle (GΩ) | cycle(GΩ) | (TΩ) | in μA) |
| 1 | 500 | 206 | 180 | 180 | 170 | 500 | Pass |
| | | | | | | | (0.08) |
| 2 | 500 | 188 | 204 | 200 | 186 | 500 | Pass |
| | | | | | | | (0.09) |
| 3 | 500 | 172 | 156 | 195 | 182 | 500 | Pass |
| | | | | | | | (0.09) |
| 4 | 500 | 174 | 162 | 175 | 182 | 500 | Pass |
| | | | | | | | (0.09) |
| Average | 500 | 185 | 175 | 187.50 | 180 | 500 | N/A |

As shown in Table 1, the coatings exhibited high MIR values over 10 cycles (a passing value is considered to be 5 GΩ and low DWV leakage. The coatings were able to handle applied high voltage without arcing across the metallic interface (Pass).

### Yellowness Factor Measurements

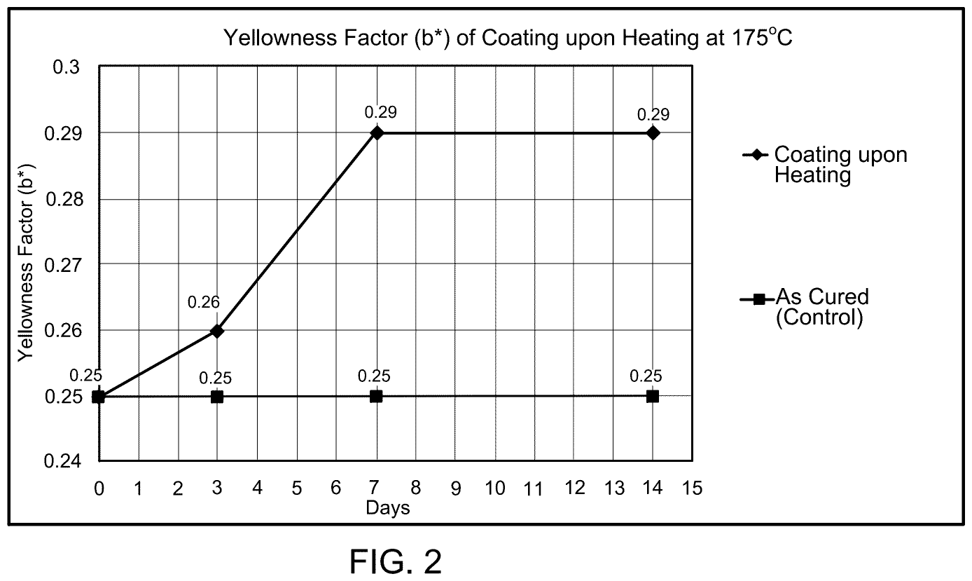

FIG. 2 shows a graph of yellowness factor over time for the coating of Example 1 upon heating at 175° C., as well control measurements for the cured coating that was not heated. As shown in FIG. 2, the coating exhibited a low yellowness factor (b*) below 0.3 over 14 days of heating.

As used herein, and unless otherwise specified, the term “about,” when used in connection with a numeric value or range of values is to indicate that the value or range of values may deviate to an extent deemed reasonable to one of ordinary skill in the art. In general, the term “about” is used herein to modify a numerical value above and below the stated value by a variance of 10% unless otherwise specified. For temperature values in degree Celsius (° C.), the term “about” is used to indicate the stated value±3° C. It is well known that instrument variation and other factors can affect the numerical values. The term “about” is to accommodate these variations. Each reference, including all patent, patent applications, and publications, cited in the present application is incorporated herein by reference in its entirety.

As used herein, and unless otherwise specified, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

What is claimed is:

1. A coating composition comprising one or more silyl-terminated polymers and one or more carriers, wherein:
the silyl-terminated polymer is present in the composition from about 5% to about 75% by weight;
the carrier is present in the composition from about 20% to about 90% by weight; and
the coating composition is suitable to provide a coating having a thickness of less than about 130 microns.

2. The coating composition of claim 1, wherein the coating has a thickness of less than about 100 microns, less than about 50 microns, less than about 25 microns, less than about 15 microns, or less than about 12.5 microns.

3. The coating composition of claim 1 or 2, wherein the coating has a thickness of less than about 12.5 microns.

4. The coating composition of any one of claims 1 to 3, wherein the coating substantially conforms to IPX7 waterproof standards of the International Electrochemical Commission.

5. The coating composition of any one of claims 1 to 4, wherein the coating is resistant against degradation from chemicals and/or sweat.

6. The coating composition of claim 5, wherein the coating has no discoloration, change in gloss, blistering, softening, swelling, and/or loss of adhesion after being exposed to chemicals in a chemical resistance test according to ASTM D-2792.

7. The coating composition of claim 6, wherein the coating is exposed to chemicals for a period of at least 24 hours.

8. The coating composition of claim 5, wherein the coating has a current leakage of less than about 0.7 μA after being immersed in an artificial sweat solution with an applied electrical power of about 9V.

9. The coating composition of claim 8, wherein the artificial sweat solution comprises about 1 g of urea, about 0.5 g of ammonium chloride, about 1 g of lactic acid, and about 1 L of water.

10. The coating composition of claim 8 or 9, wherein the coating is immersed in the artificial sweat solution for about 30 hours.

11. The coating composition of any one of claims 1 to 10, wherein the coating provides adhesion to materials selected from FR4, polyimide, ceramics, copper, and tin-plated steel.

12. The coating composition of claim 11, wherein the polyimide is a Kapton film.

13. The coating composition of any one of claims 1 to 12, wherein the coating has a surface insulation resistance (SIR) value of above about 1GΩ.

14. The coating composition of any one of claims 1 to 13, wherein the coating has a SIR value of above about 1 GΩ after more than about 20 hours, about 40 hours, about 60 hours, about 80 hours, about 100 hours, about 120 hours, about 140 hours, or about 160 hours.

15. The coating composition of any one of claims 1 to 14, wherein the coating is resistant against moisture having a moisture insulation resistance (MIR) value above about 5 GΩ.

16. The coating of any one of claims 1 to 15, wherein the coating is resistant against moisture having a MIR value above about 25 GΩ, about 50 G, about 75 GΩ, about 100 GΩ, about 125 G, about 150 GΩ, or about 165 GΩ.

17. The coating of claim 15 or 16, wherein the coating has the MIR value after one, two, three, four, five, six, seven, eight, nine, or ten temperature humidity cycles.

18. The coating composition of any one of claims 1 to 17, wherein the coating is resistant to yellowing.

19. The coating composition of claim 18, wherein the coating has a yellowness factor (b*) of below about 0.4 after heating at about 175° C.

20. The coating composition of claim 19, wherein the heating is for more than about 1 day, more than about 7 days, or more than about 14 days.

21. The coating composition of any one of claims 1 to 20, wherein the coating is resistant to thermal shock having no bubbles, cracking, delamination, and/or blistering after more than about 10 cycles, about 20 cycles, about 30 cycles, about 40 cycles, about 50 cycles, about 60 cycles, about 70 cycles, about 80 cycles, about 90 cycles, or about 100 cycles.

22. The coating composition of claim 21, wherein the cycles were carried out between about −65° C. to about 125° C.

23. The coating composition of any one of claims 1 to 22, wherein the coating is resistant to cracking and/or crazing when bent about 90°, about 120°, about 150°, or about 180° using a mandrel tester.

24. The coating composition of any one of claims 1 to 23 wherein the coating is resistant to thermal humidity aging having no discoloration, cracking, and/or delamination after being exposed to a humidity chamber.

25. The coating composition of claim 24, wherein the humidity chamber is at about 85° C. and about 95% relative humidity (RH).

26. The coating composition of claim 24 or 25, wherein the coating is exposed to the humidity chamber for more than about 30 days, more than about 60 days, more than about 90 days, or more than about 120 days.

27. The coating composition of any one of claims 1 to 26, wherein the coating has a current leakage of less than about 10 μA, less than about 5 μA, less than about 1 μA, less than about 0.5 μA, or less than about 0.1 μA as measured in a Dielectric Withstand Voltage test according to IPC-TM-650 2.5.7.1.

28. The coating composition of any one of claims 1 to 27, wherein the coating meets the minimum horizontal burning test standard as carried out according to a UL94 Flammability test.

29. The coating composition of any one of claims 1 to 28, wherein the coating does not have biological growth in a fungus resistance test according to IPC-TM-650 2.6.1.1.

30. The coating composition of claim 29, wherein the coating is exposed to fungus for a duration of about 28 days.

31. The coating composition of any one of claims 1 to 30, wherein the coating substantially conforms to Institute for Interconnecting and Packaging Electronic Circuits (IPC) requirements for an Ultra-Thin (UT) type coating according to IPC-CC-830C specification.

32. The coating composition of any one of claims 1 to 31, wherein the one or more silyl-terminated polymers comprise polyurethane, polyether, polyacrylic, or combinations thereof.

33. The coating composition of any one of claims 1 to 32, wherein the silyl-terminated polymer is present in the composition from about 5% to about 50% by weight, about 5% to about 30% by weight, about 10% to about 20% by weight, about 5% to about 15% by weight, or about 10% to about 15% by weight.

34. The coating composition of any one of claims 1 to 33, wherein the silyl-terminated polymer is present in the composition in about 13% by weight.

35. The coating composition of any one of claims 1 to 33, wherein the silyl-terminated polymer is present in the composition in about 16% by weight.

36. The coating composition of any one of claims 1 to 35, wherein the one or more carriers comprise an organic solvent.

37. The coating composition of any one of claims 1 to 36, wherein the one or more carriers comprise an alcohol.

38. The coating composition of any one of claims 1 to 37, wherein the one or more carriers comprise a C₁-C₆ alcohol.

39. The coating composition of any one of claims 1 to 38, wherein the one or more carriers comprise isopropyl alcohol.

40. The coating composition of any one of claims 1 to 36, wherein the one or more carriers comprise a hydrocarbon solvent.

41. The coating composition of any one of claims 1 to 36 and 40, wherein the one or more carriers comprise xylene and methylcyclohexane.

42. The coating composition of any one of claims 1 to 41, wherein the carrier is present in the composition from about 30% to about 85% by weight, about 50% to about 90% by weight, about 30% to about 80% by weight, about 75% to about 90% by weight, about 80% to about 90% by weight, or about 80% to about 85% by weight.

43. The coating composition of any one of claims 1 to 42, wherein the carrier is present in the composition in about 87% by weight.

44. The coating composition of any one of claims 1 to 42, wherein the carrier is present in the composition in about 80% by weight.

45. The coating composition of any one of claims 1 to 44, wherein the composition further comprises a moisture cure catalyst.

46. The coating composition of claim 45, wherein the moisture cure catalyst is a tin catalyst.

47. The coating composition of claim 45, wherein the moisture cure catalyst is a non-tin catalyst.

48. The coating composition of any one of claims 45 to 47, wherein the moisture cure catalyst is present in the composition from about 0.01 to about 2% by weight, about 0.01 to about 1% by weight, about 0.1% to about 2% by weight, or about 0.05% to about 0.1% by weight.

49. The coating composition of any one of claims 45 to 47, wherein the moisture cure catalyst is present in the composition in about 0.08% by weight.

50. The coating composition of any one of claims 45 to 47, wherein the moisture cure catalyst is present in the composition in about 0.6% by weight.

51. The coating composition of any one of claims 1 to 50, wherein the composition further comprises an amine synergist.

52. The coating composition of claim 51, wherein the amine synergist comprises 3-aminopropyltriethoxy silane.

53. The coating composition of claim 51 or 52, wherein the amine synergist is present in the composition from about 0.01% to about 15% by weight, about 0.01% to about 2% by weight, about 0.1% to about 2% by weight, or about 0.05% to about 0.5% by weight.

54. The coating composition of claim 51 or 52, wherein the amine synergist is present in the composition in about 0.1% by weight.

55. The coating composition of claim 51 or 52, wherein the amine synergist is present in the composition in about 1% by weight.

56. The coating composition of any one of claims 1 to 55, wherein the composition further comprises a crosslinker.

57. The coating composition of claim 56, wherein the crosslinker comprises tris(3-trimethoxysilylpropyl isocyanurate), tetra ethyl orthosilicate, or combinations thereof.

58. The coating composition of claim 56 or 57, wherein the crosslinker is present in the composition from about 0.01% to about 10% by weight, about 0.1% to about 10%, about 1% to about 10% by weight, or about 0.5% to about 5% by weight.

59. The coating composition of claim 56 or 57, wherein the crosslinker is present in the composition in about 1% by weight.

60. The coating composition of claim 56 or 57, wherein the crosslinker is present in the composition in about 2.4% by weight.

61. The coating composition of claim any one of claims 1 to 60, wherein the coating composition further comprises an adhesion promoter.

62. The coating composition of claim 61, wherein the adhesion promoter comprises vinyl trimethoxy silane, vinyl triethoxy silane, or combinations thereof.

63. The coating composition of claim 61 or 62, wherein the adhesion promoter is present in the composition from about 0.05% to about 5% by weight, about 0.5% to about 5% by weight, or about 0.1% to about 1% by weight.

64. The coating composition of claim 61 or 62, wherein the adhesion promoter is present in the composition in about 0.5% by weight.

65. The coating composition of any one of claims 1 to 64, wherein the composition further comprises a wetting agent.

66. The composition of claim 65, wherein the wetting agent is present in the composition from about 0.5% to about 5% by weight, about 1% to about 5% by weight, about 1% to about 3% by weight, or about 1% to about 2% by weight.

67. The composition of claim 65, wherein the wetting agent is present in the composition in about 1.5% by weight.

68. The composition of any one of claims 1 to 67, wherein the composition further comprises an optical brightener.

69. The composition of claim 68, wherein the optical brightener is present in the composition from about 0.01% to about 1% by weight, or about 0.01% to about 0.5% by weight.

70. The composition of claim 68, wherein the optical brightener is present in the composition in about 0.1% by weight.

71. The composition of any one of claims 1 to 70, wherein the composition further comprises one or more inorganic fillers.

72. The composition of claim 71, wherein the one or more inorganic fillers are present in the composition from about 0.01% to about 50% by weight.

73. The composition of any one of claims 1 to 72, wherein the composition further comprises one or more bulking agents.

74. The composition of claim 73, wherein the one or more bulking agents are present in the composition from about 0.01% to about 30% by weight.

75. The composition of any one of claims 1 to 74, wherein the composition further comprises one or more thixotropic agents.

76. The composition of claim 75, wherein the one or more thixotropic agents are present in the composition from about 0.01% to about 10% by weight.

77. The composition of any one of claims 1 to 76, wherein the composition is substantially free from fluorochemicals.

78. The composition of any one of claims 1 to 77, wherein the composition is a one-part composition.

79. The composition of any one of claims 1 to 77, wherein the composition is a two-part composition having a first-part component and a second-part component.

80. The composition of claim 79, wherein the first-part component comprises the one or more silyl-terminated polymers in one or more carriers and the second-part component comprises the moisture cure catalyst in one or more carriers.

81. The composition of claim 80, wherein the second-part component further comprises water.

82. The composition of any one of claims 1 to 81, wherein the coating composition is suitable for curing at an ambient temperature.

83. A coating composition comprising:
about 5% to about 50% silyl-terminated polymer;
about 30% to about 90% carrier;
about 0.01% to about 2% moisture cure catalyst;
about 0.01% to about 2% amine synergist;
about 0.1% to about 10% crosslinker;
about 0.05% to about 5% adhesion promoter; and
about 0.5% to about 5% wetting agent.

84. A coating composition comprising:
about 5% to about 30% silyl-terminated polymer;
about 75% to about 90% carrier;
about 0.01% to about 1% moisture cure catalyst;
about 0.05% to about 0.5% amine synergist;
about 0.5% to about 5% crosslinker;
about 0.1% to about 1% adhesion promoter; and
about 1% to about 3% wetting agent.

85. A coating composition comprising:
about 5% to about 50% silyl-terminated polymer;
about 30% to about 90% carrier;
about 0.01% to about 2% moisture cure catalyst;
about 0.01% to about 2% amine synergist; and
about 0.1% to about 10% crosslinker.

86. A coating composition comprising:
about 5% to about 30% silyl-terminated polymer;
about 75% to about 90% carrier;
about 0.01% to about 1% moisture cure catalyst;
about 0.1% to about 2% amine synergist; and
about 0.5% to about 5% crosslinker.

87. A coating composition comprising:
about 5% to about 50% silyl-terminated polymer;
about 0.01% to about 2% moisture cure catalyst;
about 0.01% to about 2% amine synergist; and
about 0.1% to about 10% crosslinker.

88. A coating composition comprising:
about 5% to about 30% silyl-terminated polymer;
about 0.01% to about 1% moisture cure catalyst;
about 0.1% to about 2% amine synergist; and
about 0.5% to about 5% crosslinker.

89. A coating composition comprising one or more silyl-terminated polymers and one or more carriers, wherein:
the coating composition is suitable to provide a coating having a thickness of less than about 12.5 microns;
the coating substantially conforms to IPX7 waterproof standards of the International Electrochemical Commission;
the coating has no discoloration, change in gloss, blistering, softening, swelling, and/or loss of adhesion after being exposed to chemicals in a chemical resistance test according to ASTM D-2792; and
the coating provides adhesion to materials selected from FR4, polyimide, ceramics, copper, and tin-plated steel.

90. A coating composition comprising one or more silyl-terminated polymers and one or more carriers, wherein:
the coating composition is suitable to provide a coating having a thickness of less than about 12.5 microns;
the coating substantially conforms to IPX7 waterproof standards of the International Electrochemical Commission;
the coating has no discoloration, change in gloss, blistering, softening, swelling, and/or loss of adhesion after being exposed to chemicals in a chemical resistance test according to ASTM D-2792;
the coating has a current leakage of less than about 0.7 μA after being immersed in an artificial sweat solution with an applied electrical power of about 9V;
the coating provides adhesion to materials selected from FR4, polyimide, ceramics, copper, and tin-plated steel;
the coating has a SIR value of above about 1 GO after more than about 20 hours;
the coating is resistant against moisture having a MIR value above about 5 GΩ;
the coating has a yellowness factor (b*) of below about 0.4 after heating at about 175° C.;
the coating is resistant to thermal shock having no bubbles, cracking, delamination, or blistering after more than about 10 cycles; and
the coating is resistant to cracking and/or crazing when bent about 90° using a mandrel tester.

91. A method of preparing the coating composition of any one of claims 1 to 90, comprising:
(a) preparing a mixture comprising the one or more silyl-terminated polymers and the one or more carriers; and
(b) stirring the mixture.

92. The method of claim 91, wherein the mixture further comprises the adhesion promoter, the crosslinker, the amine synergist, the moisture cure catalyst, and the wetting agent.

93. The method of claim 91 or 92, wherein the mixture further comprises the optical brightener.

94. The method of any one of claims 91 to 93, wherein the stirring is performed under an inert atmosphere.

95. The method of claim 94, wherein the inert atmosphere is a nitrogen or argon atmosphere.

96. The method of claim 94, wherein the inert atmosphere is a nitrogen atmosphere.

97. A method of preparing a coated substrate, comprising:
(a) applying the coating composition of any one of claims 1 to 90 to a substrate; and
(b) curing the coating composition at a temperature in a range from about 15° C. to about 80° C.

98. The method of claim 97, wherein the coating is cured at an ambient temperature.

99. The method of claim 97 or 98, wherein the applying comprises dip-coating, brushing, or spraying the coating composition.

100. An apparatus comprising the coating composition of any one of claims 1 to 90.

101. An apparatus comprising the coating composition prepared according to the method of any one of claims 91 to 96.

102. The apparatus of claim 100 or 101, wherein the apparatus is an electrical device or a medical device.

103. The apparatus of claim 102, wherein the electrical device is an electronic component, a light-emitting diode (LED), an electronic circuit board, or an electronic assembly.

104. The apparatus of claim 103, wherein the electronic assembly is a flexible electronic assembly or a rigid electronic assembly.

105. The apparatus of claim 103, wherein the electronic circuit board is an electronic printed circuit board comprising hardware that controls the flow of electrical energy to process information or control a system.

106. The apparatus of claim 102, wherein the electrical device is an LED.

107. The apparatus of claim 106, wherein the LED is able to withstand being lit upon immersion in water at an applied electrical power of about 9V.

108. The apparatus of claim 107, wherein the LED is immersed for a period of about 24 hours, about 48 hours, or about 72 hours.

109. A surface of a material coated with the coating composition of any one of claims 1 to 90.

110. A surface of a material coated with the coating composition prepared according to the method any one of claims 91 to 96.

111. A coated substrate prepared according to the method of any one of claims 97 to 99.

112. A coating composition comprising one or more silyl-terminated polymers, one or more carriers, and one or more inorganic fillers, wherein:
the silyl-terminated polymer is present in the composition from about 5% to about 75% by weight;
the carrier is present in the composition from about 20% to about 90% by weight; and
the one or more inorganic fillers are present in the composition from about 5% to about 75% by weight; and
the coating composition is suitable to provide a coating having a thickness of less than about 130 microns.

113. The coating composition of claim 112, wherein the coating has a thickness of less than about 100 microns, less than about 50 microns, less than about 25 microns, less than about 15 microns, or less than about 12.5 microns.

114. The coating composition of claim 112 or 113, wherein the coating has a thickness of less than about 12.5 microns.

115. The coating composition of any one of claims 112-114, wherein the coating is resistant to mechanical impact according to ASTM D-2794.

116. The coating composition of any one of claims 112-115, wherein is scratch resistant according to ASTM D-7027.

117. The coating composition of any one of claims 112-116, wherein the silyl-terminated polymer comprises polyurethane, polyether, polyacrylic, or combinations thereof.

118. The coating composition of any one of claims 112-117, wherein the silyl-terminated polymer is present in the composition from about 5% to about 50% by weight, about 5% to about 30% by weight, about 10% to about 20% by weight, about 5% to about 15% by weight, or about 10% to about 15% by weight.

119. The coating composition of any one of claims 112-118, wherein the carrier comprises an organic solvent.

120. The coating composition of any one of claims 112-119, wherein the carrier is present in the composition from about 30% to about 85% by weight, about 50% to about 90% by weight, about 30% to about 80% by weight, about 75% to about 90% by weight, about 80% to about 90% by weight, or about 80% to about 85% by weight.

121. The composition of any one of claims 112-120, wherein the one or more inorganic fillers are present in the composition from about 5% to about 25%, about 25% to about 50%, about 50% to about 75%, about 5% to about 50%, or about 10% to about 40% by weight.

122. The composition of any one of claims 112-121, wherein the one or more inorganic fillers comprise a metal oxide, a silicate, or combinations thereof.

123. The composition of any one of claims 112-122, wherein the one or more inorganic fillers comprise one or more toughening and ruggedization agents.

124. The composition of claim 123, wherein the toughening and ruggedization agents comprise metal oxides, silicates, aluminates, glass beads, nano-spheres, or combinations thereof.

125. The composition of claim 123 or 124, wherein the toughening and ruggedization agents comprise zinc oxide, fumed silica, aluminum oxide, silica, polymeric nano-spheres, or a combination thereof.

126. The composition of any one of claims 112-125, wherein the one or more inorganic fillers comprise one or more scratch resistance additives.

127. The composition of claim 126, wherein the one or more scratch resistance additives comprise metal oxides, montmorillonite clay, and nano-silica.

128. The composition of claim 126 or 127, wherein the one or more scratch resistance additives comprise aluminum oxide, zinc oxide, zirconium oxide, or a combination thereof.

129. The composition of any one of claims 112-128, wherein the one or more inorganic fillers have a particle size between from about 1 nm to about 10 μm.

130. The coating composition of any one of claims 112-130, wherein the composition further comprises a moisture cure catalyst.

131. The coating composition of claim 130, wherein the moisture cure catalyst is a tin catalyst.

132. The coating composition of claim 130, wherein the moisture cure catalyst is a non-tin catalyst.

133. The coating composition of any one of claims 130-133, wherein the moisture cure catalyst is present in the composition from about 0.01 to about 1% by weight, about 0.1% to about 2% by weight, or about 0.05% to about 0.1% by weight.

134. The coating composition of any one of claims 112-133, wherein the composition further comprises a crosslinker.

135. The coating composition of claim 134, wherein the crosslinker comprises tris(3-trimethoxysilylpropyl isocyanurate), tetra ethyl orthosilicate, or combinations thereof.

136. The coating composition of claim 134 or 135, wherein the crosslinker is present in the composition from about 0.01% to about 10% by weight, about 0.1% to about 10%, about 1% to about 10% by weight, or about 0.5% to about 5% by weight.

137. The coating composition of claim any one of claims 112-136, wherein the coating composition further comprises an adhesion promoter.

138. The coating composition of claim 138, wherein the adhesion promoter comprises vinyl trimethoxy silane, vinyl triethoxy silane, or combinations thereof.

139. The coating composition of claim 138 or 139, wherein the adhesion promoter is present in the composition from about 0.1% to about 1% by weight.

140. The coating composition of any one of claims 112-139, wherein the composition further comprises an amine synergist.

141. The coating composition of claim 140, wherein the amine synergist comprises 3-aminopropyltriethoxy silane.

142. The coating composition of claim 140 or 141, wherein the amine synergist is present in the composition from about 0.01% to about 15% by weight, about 0.01% to about 2% by weight, about 0.1% to about 2% by weight, or about 0.05% to about 0.5% by weight.

143. The coating composition of any one of claims 112-142, wherein the composition further comprises a wetting agent.

144. The composition of claim 143, wherein the wetting agent is present in the composition from about 0.5% to about 5% by weight, about 1% to about 5% by weight, about 1% to about 3% by weight, or about 1% to about 2% by weight.

145. The composition of any one of claims 112-144, wherein the composition further comprises one or more bulking agents.

146. The composition of claim 145, wherein the one or more bulking agents are present in the composition from about 5% to about 75% by weight.

147. The composition of claim 145 or 146, wherein the one or more bulking agents are present in the composition from about 5% to about 25%, about 25% to about 50%, about 50% to about 75%, about 5% to about 50%, or about 10% to about 40% by weight.

148. The composition of any one of claims 145-147, wherein the one or more bulking agents comprise a metal oxide, a silicate, an aluminate, glass beads, nano-spheres, nano clay or combinations thereof.

149. The composition of any one of claims 145-148, wherein the one or more bulking agents have a particle size between from about 1 nm to about 10 μm.

150. The composition of any one of claims 112-149, wherein the composition further comprises one or more UV stabilizers.

151. The composition of claim 150, wherein the one or more UV stabilizers are present in the composition from about 0.01% to about 10% by weight.

152. The composition of claim 150 or 151, wherein one or more UV stabilizers comprise a hindered amine light stabilizer.

153. The composition of any one of claims 150-152, wherein one or more UV stabilizers comprise a hindered amine light stabilizer and a benzotriazole.

154. A coating composition comprising:
about 5% to about 75% by weight silyl-terminated polymers;
about 20% to about 90% by weight carrier;
about 1% to about 20% crosslinker;
about 0.01% to about 2% moisture cure catalyst;
about 0.5% to about 5% adhesion promoter; and
about 5% to about 75% inorganic filler.

155. A method of preparing a coated substrate, comprising:
(a) applying the coating composition of any one of claims 112 to 154 to a substrate; and
(b) curing the coating composition at a temperature in a range from about 15° C. to about 80° C.

156. The method of claim 155, wherein the coating is cured at an ambient temperature.

157. The method of claim 155 or 156, wherein the applying comprises dip-coating, brushing, or spraying the coating composition.

158. The method of any one of claims 155-157, wherein the substrate is glass or plastic.

159. The method of any one of claims 155-158, wherein the coating provides protection and ruggedization of the substrate.

160. An apparatus comprising the coating composition of any one of claims 112-154.

161. A surface of a material coated with the coating composition of any one of claims 112-154.

162. A coated substrate prepared according to the method of any one of claims 155-159.

163. A coating composition comprising one or more silyl-terminated polymers, one or more carriers, and one or more anti-corrosion additives, wherein:
the silyl-terminated polymer is present in the composition from about 5% to about 75% by weight;
the carrier is present in the composition from about 20% to about 90% by weight; and
the one or more anti-corrosion additives are present in the composition from about 0.1% to about 15% by weight; and
the coating composition is suitable to provide a coating having a thickness of less than about 130 microns.

164. The coating composition of claim 163, wherein the coating has a thickness of less than about 100 microns, less than about 50 microns, less than about 25 microns, less than about 15 microns, or less than about 12.5 microns.

165. The coating composition of claim 163 or 164, wherein the coating has a thickness of less than about 12.5 microns.

166. The coating composition of any one of claims 163-165, wherein the coating is anti-corrosive according to ASTM B117.

167. The coating composition of any one of claims 163-166, wherein the coating is anti-corrosive according to MIL PRF16173E.

168. The coating composition of any one of claims 163-167, wherein the silyl-terminated polymer comprises polyurethane, polyether, polyacrylic, or combinations thereof.

169. The coating composition of any one of claims 163-168, wherein the silyl-terminated polymer is present in the composition from about 5% to about 50% by weight, about 5% to about 30% by weight, about 10% to about 20% by weight, about 5% to about 15% by weight, or about 10% to about 15% by weight.

170. The coating composition of any one of claims 163-169, wherein the carrier comprises an organic solvent.

171. The coating composition of any one of claims 163-170, wherein the carrier is present in the composition from about 30% to about 85% by weight, about 50% to about 90% by weight, about 30% to about 80% by weight, about 75% to about 90% by weight, about 80% to about 90% by weight, or about 80% to about 85% by weight.

172. The composition of any one of claims 163-171, wherein the one or more anti-corrosion additives are present in the composition from about 0.1% to about 5%, about 0.5% to about 2%, or about 1% to about 10% by weight.

173. The composition of any one of claims 163-172, wherein one or more anti-corrosion additives comprise a metal, a metal phosphate, a metal oxide, a carbamate, a benzotriazole, or a combination thereof.

174. The composition of any one of claims 163-173, wherein the one or more anti-corrosion additives comprise zinc, zinc phosphate, cerium oxide, a carbamate, a benzotriazole, or a combination thereof.

175. The coating composition of any one of claims 163-174, wherein the composition further comprises a moisture cure catalyst.

176. The coating composition of claim 175, wherein the moisture cure catalyst is a tin catalyst.

177. The coating composition of claim 175, wherein the moisture cure catalyst is a non-tin catalyst.

178. The coating composition of any one of claims 175-177, wherein the moisture cure catalyst is present in the composition from about 0.01 to about 1% by weight, about 0.1% to about 2% by weight, or about 0.05% to about 0.1% by weight.

179. The coating composition of any one of claims 163-178, further comprising a crosslinker.

180. The coating composition of claim 179, wherein the crosslinker comprises tris(3-trimethoxysilylpropyl isocyanurate), tetra ethyl orthosilicate, or combinations thereof.

181. The coating composition of claim 179 or 180, wherein the crosslinker is present in the composition from about 0.01% to about 10% by weight, about 0.1% to about 10%, about 1% to about 10% by weight, or about 0.5% to about 5% by weight.

182. The coating composition of any one of claims 163-181, wherein the composition further comprises an adhesion promoter.

183. The coating composition of claim 182, wherein the adhesion promoter comprises vinyl trimethoxy silane, vinyl triethoxy silane, or combinations thereof.

184. The coating composition of claim 182 or 183, wherein the adhesion promoter is present in the composition from about 0.1% to about 1% by weight.

185. The coating composition of any one of claims 163-184, wherein the composition further comprises one or more inorganic fillers.

186. The composition of claim 185, wherein the one or more inorganic fillers are present in the composition from about 5% to about 25%, about 25% to about 50%, about 50% to about 75%, about 5% to about 50%, or about 10% to about 40% by weight.

187. The composition of any one of claim 185 or 186, wherein the one or more inorganic fillers comprise a metal oxide, a silicate, or combinations thereof.

188. The composition of any one of claims 185-187, wherein the one or more inorganic fillers comprise one or more toughening and ruggedization agents.

189. The composition of claim 188, wherein the toughening and ruggedization agents comprise metal oxides, silicates, aluminates, glass beads, nano-spheres, or combinations thereof.

190. The composition of claim 188 or 189, wherein the toughening and ruggedization agents comprise zinc oxide, fumed silica, aluminum oxide, silica, polymeric nano-spheres, or a combination thereof.

191. The composition of any one of claims 185-190, wherein the one or more inorganic fillers comprise one or more scratch resistance additives.

192. The composition of claim 191, wherein the one or more scratch resistance additives comprise metal oxides, montmorillonite clay, and nano-silica.

193. The composition of claim 191 or 192, wherein the one or more scratch resistance additives comprise aluminum oxide, zinc oxide, zirconium oxide, or a combination thereof.

194. The composition of any one of claims 185-193, wherein the one or more inorganic fillers comprise one or more rheology modifiers.

195. The composition of claim 194, wherein the one or more rheology modifiers comprise clay, silica, chalk, or a combination thereof.

196. The composition of any one of claims 185-195, wherein the one or more inorganic fillers have a particle size between from about 1 nm to about 10 μm.

197. The coating composition of any one of claims 163-196, wherein the composition further comprises an amine synergist.

198. The coating composition of claim 197, wherein the amine synergist comprises 3-aminopropyltriethoxy silane.

199. The coating composition of claim 197 or 198, wherein the amine synergist is present in the composition from about 0.01% to about 15% by weight, about 0.01% to about 2% by weight, about 0.1% to about 2% by weight, or about 0.05% to about 0.5% by weight.

200. The coating composition of any one of claims 163-199, wherein the composition further comprises a wetting agent.

201. The composition of claim 200, wherein the wetting agent is present in the composition from about 0.5% to about 5% by weight, about 1% to about 5% by weight, about 1% to about 3% by weight, or about 1% to about 2% by weight.

202. The composition of any one of claims 163-201, wherein the composition further comprises one or more bulking agents.

203. The composition of claim 202, wherein the one or more bulking agents are present in the composition from about 5% to about 75% by weight.

204. The composition of claim 202 or 203, wherein the one or more bulking agents are present in the composition from about 5% to about 25%, about 25% to about 50%, about 50% to about 75%, about 5% to about 50%, or about 10% to about 40% by weight.

205. The composition of any one of claims 202-204, wherein the one or more bulking agents comprise a metal oxide, a silicate, an aluminate, glass beads, nano-spheres, nano clay or combinations thereof.

206. The composition of any one of claims 202-205, wherein the one or more bulking agents have a particle size between from about 1 nm to about 10 μm.

207. The composition of any one of claims 163-206, wherein the composition further comprises one or more thixotropic agents.

208. The composition of claim 207, wherein the one or more thixotropic agents are present in the composition from about 0.01% to about 25% by weight.

209. The composition of claim 207 or 208, wherein the one or more thixotropic agents comprise polyurea, hydroxypropyl methylcellulose, hydroxyethyl cellulose, or a combination thereof.

210. The composition of any one of claims 163-209, wherein the composition further comprises one or more UV stabilizers.

211. The composition of claim 210, wherein the one or more UV stabilizers are present in the composition from about 0.01% to about 10% by weight.

212. The composition of claim 210 or 211, wherein one or more UV stabilizers comprise a hindered amine light stabilizer.

213. The composition of any one of claims 210-212, wherein one or more UV stabilizers comprise a hindered amine light stabilizer and a benzotriazole.

214. The composition of any one of claims 210-213, wherein the composition further comprises one or more anti-oxidants.

215. The composition of claim 214, wherein the one or more anti-oxidants are present in the composition from about 0.01% to about 15% by weight.

216. The composition of claim 214 or 215, wherein one or more anti-oxidants comprise a hindered amine light stabilizer, a carbamate, a benzotriazole, or a combination thereof.

217. A coating composition comprising:
about 5% to about 75% by weight silyl-terminated polymers;
about 20% to about 90% by weight carrier;
about 0.1% to about 15% of the anti-corrosion additives;
about 1% to about 20% crosslinker;
about 0.01% to about 2% moisture cure catalyst;
about 0.5% to about 5% adhesion promoter; and
about 5% to about 75% inorganic filler.

218. A method of preparing a coated substrate, comprising:
(a) applying the coating composition of any one of claims 163-217 to a substrate; and
(b) curing the coating composition at a temperature in a range from about 15° C. to about 80° C.

219. The method of claim 218, wherein the coating is cured at an ambient temperature.

220. The method of claim 218 or 219, wherein the applying comprises dip-coating, brushing, or spraying the coating composition.

221. The method of any one of claims 218-220, wherein the substrate is metal.

222. The method of any one of claims 218-221, wherein the substrate is a pipeline.

223. The method of any one of claims 218-222, wherein the coating has anti-corrosive properties.

224. An apparatus comprising the coating composition of any one of claims 163-217.

225. A surface of a material coated with the coating composition of any one of claims 163-217.

226. A coated substrate prepared according to the method of any one of claims 218-223.

227. A coating composition comprising one or more silyl-terminated polymers, one or more carriers, and one or more haptic additives, wherein:
the silyl-terminated polymer is present in the composition from about 5% to about 75% by weight;
the carrier is present in the composition from about 20% to about 90% by weight; and
the one or more haptic additives are present in the composition from about 0.01% to about 10% by weight; and
the coating composition is suitable to provide a coating having a thickness of less than about 130 microns.

228. The coating composition of claim 227, wherein the coating has a thickness of less than about 100 microns, less than about 50 microns, less than about 25 microns, less than about 15 microns, or less than about 12.5 microns.

229. The coating composition of claim 227 or 228, wherein the coating has a thickness of less than about 12.5 microns.

230. The coating composition of any one of claims 227-229, wherein the coating has a Shore A hardness of from 10 to 80.

231. The coating composition of any one of claims 227-230, wherein the coating has a coefficient of friction of from about 0.1 to about 0.9.

232. The coating composition of any one of claims 227-231, wherein the coating has a plastic softening temperature of between about 10° C. and 40° C.

233. The coating composition of any one of claims 227-232, wherein the coating has a modulus of between about 1 MPa and about 10 MPa.

234. The coating composition of any one of claims 227-233, wherein the silyl-terminated polymer comprises polyurethane, polyether, polyacrylic, or combinations thereof.

235. The coating composition of any one of claims 227-234, wherein the silyl-terminated polymer is present in the composition from about 5% to about 50% by weight, about 5% to about 30% by weight, about 10% to about 20% by weight, about 5% to about 15% by weight, or about 10% to about 15% by weight.

236. The coating composition of any one of claims 227-235, wherein the carrier comprises an organic solvent.

237. The coating composition of any one of claims 227-236, wherein the carrier is present in the composition from about 30% to about 85% by weight, about 50% to about 90% by weight, about 30% to about 80% by weight, about 75% to about 90% by weight, about 80% to about 90% by weight, or about 80% to about 85% by weight.

238. The composition of any one of claims 227-237, wherein the one or more haptic additives are present in the composition from about 0.01% to about 5%, about 0.5% to about 5%, about 0.1% to about 2%, or about 1% to about 10% by weight.

239. The composition of any one of claims 227-238, wherein one or more haptic additives comprise a wax, a polymer, or a combination thereof.

240. The composition of any one of claims 227-239, wherein the one or more haptic additives comprise a micronized wax, a silicone polymer, a polyurea polymer, or a combination thereof.

241. The composition of any one of claims 227-240, wherein the composition further comprises a moisture cure catalyst.

242. The coating composition of claim 241, wherein the moisture cure catalyst is a tin catalyst.

243. The coating composition of claim 241, wherein the moisture cure catalyst is a non-tin catalyst.

244. The coating composition of any one of claims 241-243, wherein the moisture cure catalyst is present in the composition from about 0.01 to about 1% by weight, about 0.1% to about 2% by weight, or about 0.05% to about 0.1% by weight.

245. The composition of any one of claims 227-244, wherein the composition further comprises a crosslinker.

246. The coating composition of claim 245, wherein the crosslinker comprises tris(3-trimethoxysilylpropyl isocyanurate), tetra ethyl orthosilicate, or combinations thereof.

247. The coating composition of claim 245 or 246, wherein the crosslinker is present in the composition from about 0.01% to about 10% by weight, about 0.1% to about 10%, about 1% to about 10% by weight, or about 0.5% to about 5% by weight.

248. The composition of any one of claims 227-247, wherein the composition further comprises an adhesion promoter.

249. The coating composition of claim 248, wherein the adhesion promoter comprises vinyl trimethoxy silane, vinyl triethoxy silane, or combinations thereof.

250. The coating composition of claim 248 or 249, wherein the adhesion promoter is present in the composition from about 0.1% to about 1% by weight.

251. The composition of any one of claims 227-250, wherein the composition further comprises one or more inorganic fillers.

252. The composition of claim 251, wherein the one or more inorganic fillers are present in the composition from about 5% to about 25%, about 25% to about 50%, about 50% to about 75%, about 5% to about 50%, or about 10% to about 40% by weight.

253. The composition of any one of claim 251 or 252, wherein the one or more inorganic fillers comprise a metal oxide, a silicate, or combinations thereof.

254. The composition of any one of claims 251-253, wherein the one or more inorganic fillers comprise one or more toughening and ruggedization agents.

255. The composition of claim 254, wherein the toughening and ruggedization agents comprise metal oxides, silicates, aluminates, glass beads, nano-spheres, or combinations thereof.

256. The composition of claim 254 or 255, wherein the toughening and ruggedization agents comprise zinc oxide, fumed silica, aluminum oxide, silica, polymeric nano-spheres, or a combination thereof.

257. The composition of any one of claims 251-256, wherein the one or more inorganic fillers comprise one or more scratch resistance additives.

258. The composition of claim 257, wherein the one or more scratch resistance additives comprise metal oxides, montmorillonite clay, and nano-silica.

259. The composition of claim 257 or 258, wherein the one or more scratch resistance additives comprise aluminum oxide, zinc oxide, zirconium oxide, or a combination thereof.

260. The composition of any one of claims 251-259, wherein the one or more inorganic fillers comprise one or more rheology modifiers.

261. The composition of claim 260, wherein the one or more rheology modifiers comprise clay, silica, chalk, or a combination thereof.

262. The composition of any one of claims 251-261, wherein the one or more inorganic fillers have a particle size between from about 1 nm to about 10 μm.

263. The coating composition of any one of claims 227-262, wherein the composition further comprises an amine synergist.

264. The coating composition of claim 263, wherein the amine synergist comprises 3-aminopropyltriethoxy silane.

265. The coating composition of claim 263 or 264, wherein the amine synergist is present in the composition from about 0.01% to about 15% by weight, about 0.01% to about 2% by weight, about 0.1% to about 2% by weight, or about 0.05% to about 0.5% by weight.

266. The coating composition of any one of claims 227-265, wherein the composition further comprises a wetting agent.

267. The composition of claim 266, wherein the wetting agent is present in the composition from about 0.5% to about 5% by weight, about 1% to about 5% by weight, about 1% to about 3% by weight, or about 1% to about 2% by weight.

268. The composition of any one of claims 227-267, wherein the composition further comprises one or more bulking agents.

269. The composition of claim 268, wherein the one or more bulking agents are present in the composition from about 5% to about 75% by weight.

270. The composition of claim 268 or 269, wherein the one or more bulking agents are present in the composition from about 5% to about 25%, about 25% to about 50%, about 50% to about 75%, about 5% to about 50%, or about 10% to about 40% by weight.

271. The composition of any one of claims 268-270, wherein the one or more bulking agents comprise a metal oxide, a silicate, an aluminate, glass beads, nano-spheres, nano clay or combinations thereof.

272. The composition of any one of claims 268-271, wherein the one or more bulking agents have a particle size between from about 1 nm to about 10 μm.

273. The composition of any one of claims 227-272, wherein the composition further comprises one or more thixotropic agents.

274. The composition of claim 273, wherein the one or more thixotropic agents are present in the composition from about 0.01% to about 25% by weight.

275. The composition of claim 273 or 274, wherein the one or more thixotropic agents comprise polyurea, hydroxypropyl methylcellulose, hydroxyethyl cellulose, or a combination thereof.

276. The composition of any one of claims 227-275, wherein the composition further comprises one or more UV stabilizers.

277. The composition of claim 276, wherein the one or more UV stabilizers are present in the composition from about 0.01% to about 10% by weight.

278. The composition of claim 276 or 277, wherein one or more UV stabilizers comprise a hindered amine light stabilizer.

279. The composition of any one of claims 276-278, wherein one or more UV stabilizers comprise a hindered amine light stabilizer and a benzotriazole.

280. A coating composition comprising:
about 5% to about 75% silyl-terminated polymers;
about 20% to about 90% carrier;
about 0.01% to about 10% one or more haptic additives
about 1% to about 20% crosslinker;
about 0.01% to about 2% moisture cure catalyst;
about 0.5% to about 5% adhesion promoter; and
about 5% to about 75% inorganic filler.

281. A method of preparing a coated substrate, comprising:
(a) applying the coating composition of any one of claims 227 to 280 to a substrate; and
(b) curing the coating composition at a temperature in a range from about 15° C. to about 80° C.

282. The method of claim 281, wherein the coating is cured at an ambient temperature.

283. The method of claim 281 or 282, wherein the applying comprises dip-coating, brushing, or spraying the coating composition.

284. The method of any one of claims 281-283, wherein the substrate is a transportation interior, a fabric, apparel, furniture, or a leather substitute material.

285. The method of any one of claims 281-284, wherein the coating provides a soft-touch coating on the substrate.

286. An apparatus comprising the coating composition of any one of claims 227-280.

287. A surface of a material coated with the coating composition of any one of claims 227-280.

288. A coated substrate prepared according to the method of any one of claims 281-285.
